(19) United States
(12) Patent Application Publication
(10) Pub. No.: US 2024/0396729 A1
(43) Pub. Date: Nov. 28, 2024

(54) COMPACT ADAPTIVELY SECURE FUNCTIONAL ENCRYPTION FOR ATTRIBUTE-WEIGHTED SUMS

(71) Applicant: NTT RESEARCH, INC., Sunnyvale, CA (US)

(72) Inventors: Pratish DATTA, Sunnyvale, CA (US); Tapas PAL, Tokyo (JP)

(73) Assignee: NTT RESEARCH, INC., Sunnyvale, CA (US)

(21) Appl. No.: 18/681,498

(22) PCT Filed: Aug. 5, 2022
(86) PCT No.: PCT/US22/39569

§ 371 Date: Feb. 5, 2024

Related U.S. Application Data
(60) Provisional application No. 63/230,065, filed on Aug. 6, 2021.

(51) Int. Cl. H04L 9/08; H04L 9/06

(52) U.S. Cl. CPC H04L 9/0894; H04L 9/0618; H04L 9/0869

(57) ABSTRACT

Adaptively simulation secure functional encryption systems, methods, network devices, and machine-readable media for attribute-weighted sums are implemented. A secret key corresponds to some weight function ƒ, and decryption recovers a weighted sum. The schemes are built upon asymmetric bilinear groups of prime order and the security is derived under the standard (bilateral) k-Linear (k-Lin) assumption.

### FIELD OF THE INVENTION

The disclosure relates to functional encryption, and adaptively simulation secure functional encryption schemes for attribute-weighted sums.

### BACKGROUND OF THE INVENTION

Functional encryption (FE) redefines the classical encryption procedure with the motivation to overcome the limitation of the “all-or-nothing” paradigm of decryption. In a traditional encryption system, there is a single secret key such that a user given a ciphertext can either recover the whole message or learns nothing about it, depending on the availability of the secret key. FE in contrast provides fine grained access control over encrypted data by generating artistic secret keys according to the desired functions of the encrypted data to be disclosed. More specifically, in a public-key FE scheme for a function class [symbol] , there is a setup authority which produces a master secret key and publishes a master public key. Using the master secret key, the setup authority can derive secret keys or functional decryption keys SK_{ƒ} associated to functions ƒ∈ [symbol] . Anyone can encrypt messages msg belonging to a specified message space msg∈ [symbol] using the master public key to produce a ciphertext CT. The ciphertext CT along with a secret key SK_{ƒ} recovers the function of the message ƒ(msg) at the time of decryption, while unable to extract any other information about msg. More specifically, the security of FE requires collusion resistance meaning that any polynomial number of secret keys together cannot gather more information about an encrypted message except the union of what each of the secret keys can learn individually.

Prior work includes an FE scheme for a new class of functionalities termed as “attribute-weighted sums”. This is a generalization of inner product functional encryption (IPFE). In such a scheme, a database of N attribute-value pairs (xᵢ, zᵢ)_{i=1, . . . , N} are encrypted using the master public key of the scheme, where xᵢ is a public attribute (e.g., demographic data) and zᵢ is a private attribute containing sensitive information (e.g., salary, medical condition, loans, college admission outcomes). A recipient having a secret key corresponding to a weight function ƒ can learn the attribute-weighted sum of the database, i.e., Σᵢ₌₁^{N} ƒ(xᵢ)zᵢ. The attribute-weighted sum functionality appears naturally in several real life applications. For instance, if we consider the weight function ƒ as a boolean predicate, then the attribute-weighted sum functionality Σᵢ₌₁^{N} ƒ(xᵢ)zᵢ would correspond to the average zᵢ over all users whose attribute xᵢ satisfies the predicate ƒ. Important practical scenarios include average salaries of minority groups holding a particular job (zᵢ=salary) and approval ratings of an election candidate amongst specific demographic groups in a particular state (zᵢ=rating). Similarly, if zᵢ is boolean, then the attribute-weighted sum becomes Σ_{i:z}_{ᵢ}₌₁ ƒ(xᵢ). This could capture for instance the number of and average age of smokers with lung cancer (zᵢ=lung cancer, ƒ=numbers/age).

Other work considered a more general case of the notion where the domain and range of the weight functions are vectors over some finite field [symbol] . In particular, the database consists of N pairs of public/private attribute vectors (xᵢ, zᵢ)_{i=1, . . . , N} which is encrypted to a ciphertext CT. A secret key SK_{ƒ} generated for a weight function ƒ allows a recipient to learn Σᵢ₌₁^{N} ƒ(xᵢ)^{T} zᵢ from CT without revealing any information about the private attribute vectors (zᵢ)_{i=1, . . . , N}. To handle a large database where the number of users are not a-priori bounded, prior work considered the notion of unbounded-slot FE scheme for attribute-weighted sum. Thus, in their scheme, the number of slots N is not fixed while generating the system parameters and any secret key SK_{ƒ} can decrypt an encrypted database having an arbitrary number of slots. Another advantage of unbounded-slot FE is that the same system parameters and secret keys can be reused for different databases with variable lengths, which saves storage space and reduces communication cost significantly.

The unbounded-slot FE work supports expressive function class of arithmetic branching programs (ABPs) which is capable of capturing boolean formulas, boolean span programs, combinatorial computations, and arithmetic span programs. The FE scheme of prior work is built in asymmetric bilinear groups of prime order and is proven secure in the simulation-based security model, which is known to be the desirable security model for FE, under the k-Linear (k-Lin)/Matrix Diffie-Hellman (MDDH) assumption. Moreover, their scheme enjoys ciphertext size that grows with the number of slots and the size of the private attribute vectors but is independent of the size of the public attribute vectors. Towards constructing an unbounded-slot scheme, prior work first constructed a one-slot scheme and then bootstrap to the unbounded-slot scheme via a semi-generic transformation.

However, one significant limitation of the FE scheme of prior work is that the scheme only achieves semi-adaptive security. While semi-adaptive security, where the adversary is restricted to making secret key queries only after making the ciphertext queries, may be sufficient for certain applications, it is much weaker compared to the strongest and most natural notion of adaptive security which lets the adversary request secret keys both before and after making the ciphertext queries. Thus it is desirable to have an adaptively secure scheme for this important functionality that supports unbounded number of slots.

One artifact of the standard techniques for proving adaptive security of FE schemes based on the so called dual system encryption methodology is the use of a core information theoretic transition limiting the appearance of an attribute in the description of the associated functions at most once (or an a-priori bounded number of times at the expense of ciphertext and key sizes scaling with that upper bound. Recently, others have presented advanced techniques to overcome the one-use restriction. However, their techniques were designed in the context of attribute-based encryption (ABE) where attributes are totally public. Currently, it is not known how to remove the one-use restriction in the context of adaptively secure FE schemes where attributes are not fully public as is the case for the attribute-weighted sum functionality. Thus, there is a need to solve the following open problem: To construct adaptively simulation-secure one-slot/unbounded-slot FE scheme for the attribute-weighted sum functionality with the weight functions expressed as arithmetic branching programs featuring compact ciphertexts, that is, having ciphertexts that do not grow with the number of appearances of the attributes within the weight functions, from the k-Lin assumption.

### BRIEF SUMMARY OF THE INVENTION

In various embodiments, a computer-implemented method, computing device, and computer-readable storage media are disclosed. In one example embodiment for a computerized method for encrypting for a functional encryption scheme, the computer-implemented method, computing device, and computer-readable storage media can comprise: executing a computerized setup algorithm, the setup algorithm comprising: executing a functional encryption setup algorithm twice to generate a set of master public-secret key pairs FE.MSK and FE.MPK and a set of master public-secret key pairs [symbol] and [symbol] ; outputting a master secret key MSK as FE.MSK and [symbol] and a master public key MPK as FE.MPK and [symbol] , and storing the output master keys in an electronic setup storage unit; executing a computerized key generation algorithm by: receiving the master secret key MSK as FE.MSK and [symbol] from the setup storage unit and a function ƒ where ƒ comprises sub-functions ƒₜ, wherein t represents an integer index; sampling random values α, βₜ such that the sum of all entries of βₜ is 0; sampling random values rₜ for input for a garbling procedure, wherein the garbling procedure randomizes a function comprising α, ƒₜ, βₜ, wherein α and βₜ are secrets, and the garbling procedure outputs a set of label functions { [symbol] } where j runs over the number of label functions; setting values v as α and generating an FE secret key FE.SK for the values v; setting values v_{1,t} comprising [symbol] , α, and generating an FE secret key FE.SK_{1,t} for the values v_{1,t}; setting values v_{j,t} as [symbol] , and generating a FE secret key FE.SK_{j,t} for the values v_{j,t}; setting values \hat{v}ₜ comprising rₜ, α; generating a functional encryption secret key [symbol] for the values \hat{v}ₜ; and outputting the secret key SK_{ƒ} as FE.SK, {FE.SK_{j,t}}, { [symbol] } and ƒ, and storing the output in an electronic key generation storage unit.

Further embodiments can include encryption comprising: receiving the master public key MPK as FE.MPK and [symbol] , one or more public attributes x, and one or more private attributes z; sampling randomness s and setting values u comprising s, x, and computing FE ciphertext FE.CT for the value u; setting values hₜ comprising of s and z, and computing FE ciphertext [symbol] for the value hₜ; and outputting the ciphertext CT as FE.CT and [symbol] and storing the output in an electronic encryption device storage unit.

Further embodiments can include decryption comprising: receiving the function ƒ and the secret key SK_{ƒ} for function ƒ; receiving one or more public attributes x and a ciphertext CT for x; retrieving FE.SK, FE.SK_{j,t}, [symbol] from SK_{ƒ} and retrieving FE.CT and [symbol] from CT; retrieving sub-functions ƒₜ from the function ƒ; decrypting FE.CT by running the decryption algorithm of FE using the secret key FE.SK and get a value ρ; decrypting FE.CT by running the decryption algorithm of FE using the secret key FE.SK_{j,t} and get a value [symbol] ; decrypting [symbol] by running the decryption algorithm of FE using the secret key [symbol] and get a value [symbol] ; running the evaluation algorithm of the garbling scheme using the values [symbol] , [symbol] and the one or more public attributes x and the sub-function ƒₜ, and get a value d; and recovering the functional value μ from ρ and d, and outputting the value μ as the plaintext and storing the output in an electronic decryption device storage unit.

In further embodiments, the first set is for encrypting a public part of attributes and the second set is for use in encrypting a private part of the attributes.

### BRIEF DESCRIPTION OF THE DRAWINGS

The accompanying drawings, which are included to provide further understanding and are incorporated in and constitute a part of this specification, illustrate disclosed embodiments, and together with the description, serve to explain the principles of the disclosed embodiments. In the drawings:

FIG. 1 illustrates an example embodiment of the present invention for a functional encryption system that is adaptively secure for attribute-weighted sums.

FIG. 2 illustrates an example system architecture for a functional encryption system that is adaptively secure for attribute-weighted sums.

FIG. 3 illustrates an example computer system architecture for implementing the claimed systems and methods.

FIG. 4 illustrates further details of an example computer system architecture for implementing the claimed systems and methods.

### DETAILED DESCRIPTION

As disclosed herein, we resolve the above open problem. More precisely, we make the following contributions.
(a) We start by presenting the first one-slot FE scheme for the attribute-weighted sum functionality with the weight functions represented as ABPs that achieves adaptive simulation-based security and compact ciphertexts, that is, the ciphertext size is independent of the number of appearances of the attributes within the weight functions. The scheme is secure against an adversary who is allowed to make an a-priori bounded number of ciphertext queries and an unbounded (polynomial) number of secret key queries both before and after the ciphertext queries, which is the best possible level of security one could hope to achieve in adaptive simulation-based framework. Since simulation-based security also implies indistinguishability-based security and indistinguishability-based security against single and multiple ciphertexts are equivalent, the proposed FE scheme is also adaptively secure in the indistinguishability-based model against adversaries making unbounded number of ciphertext and secret key queries in any arbitrary order.
(b) We next bootstrap our one-slot scheme to an unbounded-slot scheme that also achieves simulation-based adaptive security against a bounded number of ciphertext queries and an unbounded polynomial number of secret key queries. Just like our one-slot scheme, the ciphertexts of our unbounded-slot scheme also do not depend on the number of appearances of the attributes within the weight functions. However, the caveat here is that the number of pre-ciphertext secret key queries is a priori bounded and all parameters of the scheme, namely, the master public key, ciphertexts, and secret keys scale linearly with that upper bound.

The disclosed FE schemes are built upon asymmetric bilinear groups of prime order. We prove the security of our FE schemes based on the standard (bilateral) k-Lin/(bilateral) MDDH assumption(s). Thus our results can be summarized as follows.

Theorem 1 (Informal) Under the (bilateral) k-Lin/MDDH assumption(s), there exist adaptively simulation secure one-slot/unbounded-slot FE scheme for attribute-weighted sums against a bounded number of ciphertext and an unbounded number of secret-key queries, and having compact ciphertexts, that is, without the one-use restriction, in bilinear groups of prime order.

The bilateral MDDH assumption is the plain MDDH assumption except that the elements are available in the exponents of both source groups of a bilinear group simultaneously. This assumption has recently been utilized in the context of achieving FE for quadratic functions in the standard model and broadcast encryption scheme with O(N^{1/3}) parameter sizes from bilinear maps, where N is the total number of users in the system. Unlike prior work, our construction is semi-generic and is built upon two cryptographic building blocks, namely a slotted inner product functional encryption (IPFE), which is a hybrid of a public-key IPFE and a private-key function-hiding IPFE, and an information theoretic primitive called arithmetic key garbling scheme (AKGS). For bootstrapping from one-slot to unbounded-slot construction, we make use of a semi-generic transformation, but analyze its security in the adaptive simulation-based setting as opposed to the semi-adaptive setting. By attribute-hiding, we mean the so-called “strong” attribute-hiding, as stipulated by the security definitions of FE, meaning that private attributes must remain hidden even to decryptors who are able to perform a successful decryption. FE schemes under standard computational assumptions.

The techniques of prior work are developed to achieve compact ciphertexts, that is, without the one-use restriction in the context of indistinguishability-based adaptively secure ABE (that is, for payload-hiding security and not attribute-hiding). In this work, we extend their techniques to overcome the one-use restriction into the context of adaptive simulation-based attribute-hiding security for the first time. The high level approach of prior work to mitigate the one-use restriction is to replace the core information theoretic step of the dual system technique with a computational step. However the application of this strategy in their framework crucially rely on the payload hiding security requirement, that is, the adversaries are not allowed to query secret keys that enable a successful decryption. In contrast, in the setting of attribute-hiding, adversaries are allowed to request secret keys enabling successful decryption and extending the technique of prior work into this context appears to be non-trivial. We resolve this by developing a three-slot variant of their framework, integrating the pre-image sampleability of the inner product functionality, and carefully exploiting the structures of the underlying building blocks, namely AKGS and slotted IPFE.

Herein is disclosed the first adaptively simulation secure functional encryption (FE) schemes for attribute-weighted sums. In such an FE scheme, encryption takes as input N pairs of attribute {(xᵢ, zᵢ)}_{i∈[N]} for some N∈ [symbol] where the attributes {xᵢ}_{i∈[N]} are public while the attributes {zᵢ}_{i∈[N]} are private. The indices i∈[N] are referred to as the slots. A secret key corresponds to some weight function ƒ, and decryption recovers the weighted sum Σᵢ₌₁^{N}ƒ(xᵢ)zᵢ. This is an important functionality with a wide range of potential real life applications. In the proposed FE schemes attributes are viewed as vectors and weight functions are arithmetic branching programs (ABP). We present two schemes with varying parameters and levels of adaptive security.
(a) We first present a one-slot scheme that achieves adaptive security in the simulation-based security model against a bounded number of ciphertext queries and an arbitrary polynomial number of secret key queries both before and after the ciphertext queries. This is the best possible level of security one can achieve in the adaptive simulation-based framework. From the relations between the simulation-based and indistinguishability-based security frameworks for FE, it follows that the proposed FE scheme also achieves indistinguishability-based adaptive security against an a-priori unbounded number of ciphertext queries and an arbitrary polynomial number of secret key queries both before and after the ciphertext queries. Moreover, the scheme enjoys compact ciphertexts that do not grow with the number of appearances of the attributes within the weight functions.
(b) Next, bootstrapping from the one-slot scheme, we present an unbounded-slot scheme that achieves simulation-based adaptive security against a bounded number of ciphertext and pre-ciphertext secret key queries while supporting an a-priori unbounded number of post-ciphertext secret key queries. The scheme achieves public parameters and secret key sizes independent of the number of slots N and a secret key can decrypt a ciphertext for any a-priori unbounded N. Further, just like the one-slot scheme, this scheme also has the ciphertext size independent of the number of appearances of the attributes within the weight functions. However, all the parameters of the scheme, namely, the master public key, ciphertexts, and secret keys scale linearly with the bound on the number of pre-ciphertext secret key queries.

Our schemes are built upon asymmetric bilinear groups of prime order and the security is derived under the standard (bilateral) k-Linear (k-Lin) assumption. Our work resolves an open problem posed by an unbounded-slot FE scheme for attribute-weighted sum achieving only semi-adaptive simulation security. At a technical level, the invention extends the adaptive security framework devised to achieve compact ciphertexts in the context of indistinguishability-based payload-hiding security into the setting of simulation-based adaptive attribute-hiding security.

### Technical Overview

In this section, we present our main technical ideas. Let G=( [symbol] , [symbol] , [symbol] , g₁, g₂, e) be a bilinear group of prime order p and [symbol] denotes gᵢ^{a} for any a∈ [symbol] and i∈{1, 2, T}, which notation can also be extended in case of vectors and matrices. At the top most level of strategy, we first design an adaptively simulation-secure one-slot FE scheme and then apply a compiler to bootstrap to an unbounded-slot scheme. For the later part, we use a known compiler, however, the known compiler only works in the context of semi-adaptive security, that is, the compiler can bootstrap a semi-adaptively secure one-slot FE scheme to a semi-adaptively secure unbounded-slot scheme. In contrast, we analyze the security of the same transformation in the context of the simulation-based adaptive security framework. We observe that in order to prove the adaptive security for the compiler, the (bilateral) k-Lin/(bilateral) MDDH assumption is needed whereas for semi-adaptive security, the plain k-Lin/MDDH was sufficient. Moreover, we are only able to establish the simulation-based adaptive security for the transformation for settings where only a bounded number of secret-key queries are allowed prior to making the ciphertext queries.

The technical ideas disclosed herein lie in the design and analysis of our one-slot scheme which we describe first in this technical overview. Next, we would briefly explain the modifications to our one-slot scheme leading to our extended one-slot scheme, followed by explaining our analysis of the one-slot to an unbounded-slot bootstrapping compiler applied on our one-slot extended FE (extFE) scheme.

Recall that the adaptive simulation security of an FE scheme is proven by showing the indistinguishability between a real game with all the real algorithms and an ideal game where a simulator simulates all the ciphertexts and secret keys queried by the adversary. When an adversary makes a pre-ciphertext query for some function ƒ, the simulator provides the secret key to the adversary. When the adversary makes a challenge ciphertext query for an attribute vector pair (x,z), the simulator receives the information of x but not z. Instead it receives the functional values ƒ(x)^{T}z for all the pre-ciphertext secret keys. Based on this information, the simulator must simulate the challenge ciphertext. Finally, when an adversary makes a secret-key query for some function ƒ after making a ciphertext query, the simulator receives ƒ along with the functional value ƒ(x)^{T}z for that key and simulates the key based on this information.

Designing Adaptively Simulation Secure One-Slot extFE

Arithmetic Key Garbling Schemes The notion is called arithmetic key garbling scheme (AKGS) which garbles a function ƒ: [symbol] → [symbol] along with two secrets α, β∈ [symbol] so that the evaluation with an input x∈ [symbol] gives the value αƒ(x)+β. Note that the evaluation does not reveal any information about α and β. In particular, the AKGS has the following algorithms:
( [symbol] , . . . , [symbol] )←Garble(αƒ(x)+β; r): The garbling algorithm outputs (m+1) affine label functions L₁, . . . , Lₘ₊₁, described by their coefficient vectors [symbol] , . . . , [symbol] over [symbol] , using the randomness r∈ [symbol] where (m+1) denotes the size of the function ƒ.
γ←Eval(ƒ, x, [symbol] , . . . , [symbol] ): The linear evaluation procedure recovers γ=αƒ(x)+β using the input x and the label function values [symbol] =Lⱼ(x)= [symbol] ·(1,x)∈ [symbol] .

AKGS is a partial garbling process as it only hides α,β which is captured by the usual simulation security. The simulator produces simulated labels ( [symbol] , . . . , [symbol] )←SimGarble(ƒ, x, αƒ(x)+β) which is the same distribution as the actual label function values evaluated at input x.

Function-Hiding Slotted IPFE A private-key function-hiding inner product functional encryption (IPFE) scheme based on a bilinear group G=( [symbol] , [symbol] , [symbol] , g₁, g₂, e) generates secret keys IPFE.SK for vectors [symbol] ∈ [symbol] and produces ciphertexts IPFE.CT for vectors [symbol] ∈ [symbol] using the master secret key of the system. Both the key generation and encryption algorithm perform linear operations in the exponent of the source groups [symbol] , [symbol] respectively. The decryption recovers the inner product [symbol] ∈ [symbol] in the exponent of the target group. The sizes of the secret keys, IPFE.SK, and ciphertexts, IPFE.CT, in such a system grow linearly with the sizes of the vectors v and u respectively. Roughly, the function-hiding security of an IPFE ensures that no information about the vectors v, u is revealed from IPFE.SK and IPFE.CT except the inner product value v·u which is trivially extracted using the decryption algorithm. One slotted version of IPFE is a hybrid between a secret-key function-hiding IPFE and a public-key IPFE. The index set of the vectors u is divided into two subsets: public slots S_{pub} and private slot Sₚᵣᵢᵥ so that the vector u is written as u=(u_{pub}∥uₚᵣᵢᵥ). With addition to the usual (secret-key) encryption algorithm, the slotted IPFE has another encryption algorithm that uses the master public key of the system to encrypt the public slots of u, i.e. vectors with uₚᵣᵢᵥ=0. The slotted IPFE preserves the function-hiding security with respect to the private slots only as anyone can encrypt arbitrary vectors into the public slots.

### Our One-Slot FE.

We aim to design our decryption algorithm such that given a secret key for a weight function ABP ƒ: [symbol] → [symbol] with coordinate functions ƒ₁, . . . , ƒₙ: [symbol] → [symbol] and an encryption of an attribute vector pair (x,z)∈ [symbol] × [symbol] , the decryption algorithm would first recover the value for each coordinate z[t]ƒₜ(x) masked with a random scalar βₜ, that is, z[t]ƒₜ(x)+βₜ and then sum over all these values to obtain the desired functional value (we take the scalars {βₜ}_{t∈[n′]} such that Σₜ₌₁^{n′}βₜ=0 mod p). Thus we want our key generation algorithm to use AKGS to garble the functions z[t]ƒₜ(x)+βₜ. Note that here, βₜ is a constant but z[t] is a variable. While doing this garbling, we also want the label functions to involve either only the variables x or the variable z[t]. This is because, in the construction we need to handle x and z[t] separately since x is public whereas z[t] is private. This is unlike prior work which garbles αƒ(x)+β where both α, β are known constants and only x is a variable. To solve this issue, we garble an extended ABP where we extend the original ABP ƒₜ by adding a new sink node and connecting the original sink node of ƒₜ to this new sink node with a directed edge labeled with the variable z[t].

We also make use of a particular instantiation of AKGS where we observe that the first m coefficient vectors [symbol] , . . . , [symbol] are independent of z[t] and the last coefficient vector [symbol] involves only the variable z[t]. In the setup phase two pairs of IPFE keys (IPFE.MSK, IPFE.MPK) and ( [symbol] , [symbol] ) for a slotted IPFE are generated for appropriate public and private index sets. The first instance of IPFE is used to handle the public attributes x, whereas the second instance for the private attributes z. Let ƒ=(ƒ₁, . . . , ƒ_{n′}): [symbol] → [symbol] be a given weight function ABP such that ƒₜ: [symbol] → [symbol] is the t-th coordinate ABP of ƒ. To produce a secret-key SK_{ƒ}, we proceed as follows:
Sample vectors α, βₜ← [symbol] such that Σ_{t∈[n′]}βₜ[t]=0 mod p ∀ₜ∈[k]
Suppose we want to base the security of the proposed scheme under the MDDHₖ assumption. Generate k instances of the garblings ( [symbol] , . . . , [symbol] )←Garble(α[ι]z[t]ƒₜ(x)+βₜ[ι]; rₜ^{(ι)}) for ι∈[k] where rₜ^{(ι)}← [symbol] . Using an instantiation of AKGS, we have that the (m+1)-th label functions L_{m+1,t}^{(ι)} take the form L_{m+1,t}^{(ι)}(z[t])=α[ι]z[t]−rₜ^{(ι)}[m] with α[ι] a constant.
Compute the IPFE secret keys

IPFE.SK=IPFE.KeyGen(IPFE.MSK, [symbol] ,0ₖₙ∥0,0ₙ,0_{n′} [symbol] )

IPFE.SK_{j,t}=IPFE.KeyGen(IPFE.MSK, [symbol] , . . . , [symbol] ∥0,0n,0_{n′},0_{n′} [symbol] ) for j∈[m]

[symbol]

=IPFE.KeyGen( [symbol] , [symbol] , . . . ,rₜ^{(k)}[m],α∥0,0,0,0,0,0,0 [symbol] )
Return SK_{ƒ}=(IPFE.SK, {IPFE.SK_{j,t}}_{j∈[m],t∈[n′]}, { [symbol] }_{t∈[n′]})

Here, we separate public and private slots by “∥” and 0 denotes a vector of all zero elements. Now, to produce a ciphertext CT for some attribute vectors (x,z), we use the following steps:
Sample s← [symbol] and use the slotted encryption of IPFE to compute the ciphertexts

$$\begin{matrix}IPFE . CT = IPFE . SlotEnc ( IPFE . MSK , {〚 s , s ⊗ x 〛}_{1} ) \\ = IPFE . SlotEnc ( , {〚 - s , s \cdot z [ t ] 〛}_{1} ) for all t ∈ [ {n}^{′} ]\end{matrix}$$

where ⊗ denotes the tensor product.
return CT=(IPFE.CT, { [symbol] }_{t∈[n′]})

Decryption first uses IPFE.Dec to compute

$$v \cdot u = {〚 α \cdot s 〛}_{T} \qquad ( 1 )$$

$${v}_{j , t} \cdot u = {〚 {\sum }_{ι} s [ ι ] ( {ℓ}_{j , t}^{( ι )} \cdot ( 1 , x ) ) 〛}_{T} = {〚 {ℓ}_{j , t} 〛}_{T} for j ∈ [ m ] , t ∈ [ {n}^{′} ] \qquad ( 2 )$$

$${v}_{m + 1 , t} \cdot {h}_{t} = {〚 {\sum }_{ι} s [ ι ] ( α [ ι ] z [ t ] - {r}_{t}^{( ι )} [ m ] ) 〛}_{T} = {〚 {ℓ}_{m + 1 , t} 〛}_{T} for t ∈ [ {n}^{′} ] \qquad ( 3 )$$

and then apply the evaluation procedure of AKGS to get

$$Eval ( {f}_{t} , x , {〚 {ℓ}_{j , t} 〛}_{T} , … , {〚 {ℓ}_{m + 1 , t} 〛}_{T} ) = {〚 ( α \cdot s ) \cdot z [ t ] {f}_{t} ( x ) + {β}_{t} \cdot s 〛}_{T} . \qquad ( 4 )$$

Finally, multiplying all these evaluated values and utilizing the fact Σ_{tE[n′]}βₜ·s=0, we recover ƒ(x)^{T}z=Σ_{t∈[n′]}z[t]ƒₜ(x).

The Simulator for Our One-Slot FE Scheme We now describe our simulator of the adaptive game for our one-slot FE scheme. Note that the private slots on the right side of “∥” will be used by the simulator and we program them during the security analysis. For the q-th secret-key query corresponding to a function ƒ_{q}=(ƒ_{q,1}, . . . , ƒ_{q,n′}), the simulator sets public slots of all the vectors v_{q}, v_{q,j,t} for j∈{1, . . . , m_{q}+1} as in the original key generation algorithm. Instead of using the linear combination of the label vectors, the simulator uses freshly sampled garblings to set the private slots. The pre-challenge secret key SK_{ƒ}_{_{q}} takes the form

$$IPFE . {SK}_{q} = IPFE . KeyGen ( IPFE . MSK , {〚 α [ ι ] , {0}_{kn} ‖ {\tilde{α}}_{q} , {0}_{n} , {0}_{{n}^{′}} , {0}_{{n}^{′}} 〛}_{2} )$$

$$IPFE . {SK}_{q , j , t} = IPFE . KeyGen ( IPFE . MSK , {〚 {ℓ}_{q , j , t}^{( 1 )} , … , {ℓ}_{q , j , t}^{( k )} ‖ {\tilde{ℓ}}_{q , j , t} , {0}_{{n}^{′}} , {0}_{{n}^{′}} 〛}_{2} ) for j ∈ [ {m}_{q} ]$$

$$= IPFE . \text{} KeyGen ( , {〚 {r}_{t}^{( 1 )} [ {m}_{q} ] , … , {r}_{t}^{( k )} [ {m}_{q} ] , α ‖ 0 , 0 , {\tilde{r}}_{q , t} [ {m}_{q} ] , {\tilde{α}}_{q} , 0 , 0 , 0 〛}_{2} )$$

where ( [symbol] , . . . , [symbol] )←Garble(\tilde{α}_{q}z[t]ƒ_{q,t}(x)+β_{q,t}; \tilde{r}_{q,t}), \tilde{α}_{q}, β_{q,t}← [symbol] such that Σ_{t∈[n′]}β_{q,t}=0 mod p. We write 0_{ξ} as a vector of length ξ with all zero elements. To simulate the ciphertext for the challenge attribute x*, the simulator uses the set of all functional values [symbol] ={(ƒ_{q}, ƒ_{q}(x*)^{T}z*):q∈[Qₚᵣₑ]} to compute a dummy vector d satisfying ƒ_{q}(x*)^{T}d=ƒ_{q}(x*)^{T}z* for all q∈[Qₚᵣₑ]. Since the inner product functionality is pre-image sampleable and both ƒ_{q}, x* are known to the simulator, a dummy vector d can be efficiently computed via a polynomial time algorithm. The simulated ciphertext becomes

$$\begin{matrix}IPFE . CT = IPFE . Enc ( IPFE . MSK , {〚 {0}_{k} , {0}_{k n} ‖ 1 , {x}^{*} , {0}_{{n}^{′}} , {0}_{{n}^{′}} 〛}_{1} ) \\ = IPFE . Enc ( , {〚 {0}_{k} , {0}_{k} ‖ 1 , 0 , - 1 , d [ t ] , 0 , 0 , 0 〛}_{1} )\end{matrix}$$

The post-challenge secret-key query for the q-th function ƒ_{q}=(ƒ_{q,1}, . . . , ƒ_{q,n′}) with q>Qₚᵣₑ is answered using the simulator of AKGS. In particular, we choose β_{q,t}← [symbol] satisfying Σ_{t∈[n′]}β_{q,t}=0 mod p and compute the simulated labels as follows:

$$( , … , ) ← SimGarble ( {f}_{q , 1} , {x}^{*} , {\tilde{α}}_{q} \cdot {{f}_{q} ( {x}^{*} )}^{T} {z}^{*} + {β}_{q , 1} ) \qquad ( 5 )$$

$$( , … , ) ← S i m G a r b l e ( {f}_{q , t} , {x}^{*} , {β}_{q , t} ) for 1 < t \leq {n}^{′} \qquad ( 6 )$$

Note that, for post-challenge secret keys the functional value ƒ_{q}(x*)^{T}z* is known and hence the simulator can directly embed the value into the secret keys. The post-challenge secret key SK_{fq} takes the form

$$IPFE . {SK}_{q} = IPFE . KeyGen ( IPFE . MSK , {〚 α , {0}_{kn} ‖ {\tilde{α}}_{q} , {0}_{n} , {0}_{{n}^{′}} , {0}_{{n}^{′}} 〛}_{2} )$$

$$IPFE . {SK}_{q , j , t} = IPFE . KeyGen ( IPFE . MSK , {〚 {ℓ}_{j , t}^{( 1 )} , … , {ℓ}_{j , t}^{( k )} ‖ {ℓ}_{q , j , t} , {0}_{n} , {0}_{{n}^{′}} , {0}_{{n}^{′}} 〛}_{2} ) for j ∈ [ \text{} {m}_{q} ]$$

$$= IPFE . \text{} KeyGen ( , {〚 {r}_{t}^{( 1 )} [ {m}_{q} ] , … , {r}_{t}^{( k )} [ {m}_{q} ] , α ‖ {ℓ}_{q , {m}_{q} + 1 , t} , 0 , 0 , 0 , 0 , 0 , 0 〛}_{2} )$$

Bootstrapping from One-Slot FE to Unbounded-Slot FE

Prior work includes a compiler that upgrades the one-slot FE into an unbounded-slot FE scheme where the number of slots N can be arbitrarily chosen at the time of encryption. The transformation also preserves the compactness of ciphertexts of the underlying one-slot scheme. However, their transformation actually needs a one-slot extFE scheme as defined above.

### Preliminaries

In this section, we provide the necessary definitions and backgrounds that will be used in the sequence.

Notations We denote by λ the security parameter that belongs to the set of natural number [symbol] and 1^{λ} denotes its unary representation. We use the notation s←S to indicate the fact that s is sampled uniformly at random from the finite set S. For a distribution [symbol] , we write x← [symbol] to denote that x is sampled at random according to distribution [symbol] . A function negl: [symbol] ← [symbol] is said to be a negligible function of λ, if for every c∈ [symbol] there exists a λ_{c}∈ [symbol] such that for all λ>λ_{c}, |negl(λ)<λ^{-c}.

Let Expt be an interactive security experiment played between a challenger and an adversary, which always outputs a single bit. We assume that [symbol] is a function of λ and it is parametrized by an adversary [symbol] and a cryptographic protocol C. Let [symbol] and [symbol] be two such experiment. The experiments are computationally/statistically indistinguishable if for any PPT/computationally unbounded adversary [symbol] there exists a negligible function negl such that for all λ∈ [symbol] ,

$${Adv}_{𝒜}^{C} ( λ ) = \vert Pr [ 1 ← {Expt}_{𝒜}^{C , 0} ( {1}^{λ} ) ] - Pr [ 1 ← {Expt}_{𝒜}^{C , 1} ( {1}^{λ} ) ] \vert < negl ( λ )$$

We write

$${Expt}_{A}^{C , 0} {\approx }^{c} {Expt}_{A}^{C , 1}$$

if they are computationally indistinguishable (or simply indistinguishable). Similarly,

$${Expt}_{A}^{C , 0} {\approx }^{s} {Expt}_{A}^{C , 1}$$

means statistically indistinguishable and [symbol] ≡ [symbol] means they are identically distributed.

For n∈ [symbol] , we denote [n] the set {1, 2, . . . , n} and for n, m∈ [symbol] with n<m, we denote [n, m] be the set {n, n+1, . . . , m}. We use lowercase boldface, e.g., v, to denote column vectors in [symbol] and uppercase boldface, e.g., M, to denote matrices in [symbol] for p, n, m∈ [symbol] . The i-th component of a vector v∈ [symbol] is written as v[i] and the (i,j)-th element of a matrix M∈ [symbol] is denoted by M[i,j]. The transpose of a matrix M is denoted by M^{T} such that M^{T}[i,j]=M[j,i]. To write a vector of length n with all zero elements we write 0ₙ or simply 0 when the length is clear from the context. Let u, v∈ [symbol] , then the inner product between the vectors is denoted as u·v=u^{T}v=Σ_{i∈[n]}u[i]v[i]∈ [symbol] .

Let ƒ: [symbol] → [symbol] be an affine function with coefficient vector f=(f[const], f[coef₁], . . . f[coefₙ]). Then for any x∈ [symbol] , we have ƒ(x)=f[const]+Σ_{i∈[n]}f[coefᵢ]x[i]∈ [symbol] .

### Bilinear Groups and Hardness Assumptions

We use a pairing group generator [symbol] that takes as input 1^{λ} and outputs a tuple G=( [symbol] , [symbol] , [symbol] , g₁,

g₂, e) where [symbol] , [symbol] , [symbol] are groups of prime order p=p(λ) and gᵢ is a generator of the group [symbol] for i∈{1,2}. The map e: [symbol] × [symbol] → [symbol] satisfies the following properties:
bilinear: e(g₁^{a},g₂^{b})=e(g₁,g₂)^{ab} for all a, b∈ [symbol] .
non-degenerate: e(g₁,g₂) generates [symbol] .

The group operations in [symbol] for i∈{1, 2, T} and the map e are efficiently computable in deterministic polynomial time in the security parameter λ. For a matrix A and each i∈{1, 2, T}, we use the notation [symbol] to denote gᵢ^{A} where the exponentiation is element-wise. The group operation is written additively while using the bracket notation i.e. [symbol] + [symbol] = [symbol] + [symbol] for matrices A and B. Observe that, given A and [symbol] we can efficiently compute [symbol] =A· [symbol] . We write the pairing operation multiplicatively, i.e. e( [symbol] , [symbol] )= [symbol] = [symbol] .

Assumption 1 (Matrix Diffie-Hellman Assumption) Let k=k(λ), [symbol] = [symbol] (λ), q=q(λ) be positive integers. We say that the [symbol] assumption holds in [symbol] (i∈{1, 2, T}) if for all PPT adversary [symbol] there exists a negligible function negl such that

$${Adv}_{𝒜}^{{MDDH}_{k , ℓ}^{q}} ( λ ) = \begin{matrix}\vert Pr [ 1 ← 𝒜 ( G , {〚 A 〛}_{i} , {〚 {S}^{T} A 〛}_{i} ) ] - Pr [ 1 ← 𝒜 ( G , {〚 A 〛}_{i} , {〚 U 〛}_{i} ) ] \vert < negl ( λ ) \\ where G = ( {𝔾}_{1} , {𝔾}_{2} , {𝔾}_{T} , {g}_{1} , {g}_{2} , e ) ← 𝒢 ( {1}^{λ} ) , A ← {ℤ}_{p}^{k \times ℓ} , S ← {ℤ}_{p}^{k \times q} and U ← {ℤ}_{p}^{k \times ℓ} .\end{matrix}$$

Prior work showed that the k-Linear (k-Lin) assumption implies MDDH_{k,k+1}¹ and MDDH_{k,k+1}¹ implies [symbol] for all k, q∈ [symbol] and [symbol] >k with a tight security reduction. Henceforth, we will use MDDHₖ to denote MDDH_{k,k+1}¹.

We consider bilateral [symbol] assumption which is a strengthening of the [symbol] assumption. The bilateral [symbol] assumption is defined as follows.

Assumption 2 (Bilateral Matrix Diffie-Hellman Assumption) Let k=k(λ), [symbol] = [symbol] (λ),q=q(λ) be positive integers. We say that the bilateral [symbol] ( [symbol] ) assumption holds if for all PPT adversary [symbol] there exists a negligible function negl such that

$${Adv}_{𝒜}^{{bMDDH}_{k , ℓ}^{q}} ( λ ) = \vert Pr [ 1 ← 𝒜 ( G , {\{ {〚 A 〛}_{i} , {〚 {S}^{T} A 〛}_{i} \}}_{i ∈ \{ 1 , 2 \}} ) ] - Pr [ 1 ← 𝒜 ( G , {\{ {〚 A 〛}_{i} , {〚 U 〛}_{i} \}}_{i ∈ \{ 1 , 2 \}} ) ] \vert < negl ( λ ) \\ where G = ( {𝔾}_{1} , {𝔾}_{2} , {𝔾}_{T} , {g}_{1} , {g}_{2} , e ) ← 𝒢 ( {1}^{λ} ) , A ← {ℤ}_{p}^{k \times ℓ} , S ← {ℤ}_{p}^{k \times q} and U ← {ℤ}_{p}^{k \times ℓ} .$$

### Arithmetic Branching Program

Arithmetic Branching Program (ABP) is a computational model that can be used to model boolean formula, boolean branching program or arithmetic formula through a linear time reduction with a constant blow-up in their respective sizes. In this work, we consider ABP over [symbol] .

Definition 1 (Arithmetic Branching Program) An arithmetic branching program (ABP) over [symbol] is a weighted directed acyclic graph (V F, E, ϕ, v₀, v₁), where V is the set of all vertices, E is the set of all edges, ϕ:E→( [symbol] → [symbol] ) specifies an affine weight function for each edge, and v₀, v₁∈V are two distinguished vertices (called the source and the sink respectively). The in-degree of v₀ and the out-degree of v₁ are 0. It computes a function ƒ: [symbol] → [symbol] given by

$$f ( x ) = ϕ ( e ) ( x )$$

where [symbol] is the set of all v₀-v₁ path and e∈P denotes an edge in the path P∈ [symbol] . The size of the ABP is |V|, the number of vertices.

We denote by [symbol] the class of ABPs over [symbol] :

[symbol]

={ƒ|ƒ is an ABP over [symbol] for some prime p and positive integer n}

The class of ABP can be extended in a coordinate-wise manner to a ABPs ƒ: [symbol] → [symbol] . More precisely, an ABP ƒ: [symbol] → [symbol] has all its weight functions ϕ(ϕ₁, . . . , ϕ_{n′}):E→( [symbol] → [symbol] ) with each coordinate function ϕₜ for t∈[n′] of ϕ being an affine function in x having scalar constants and coefficients. Therefore, such a function ƒ can be viewed as ƒ=(ƒ₁, . . . , ƒₐ) with each coordinate function ƒₜ: [symbol] → [symbol] being an ABP that has the same underlying graph structure as that of ƒ and having ϕₜ:E→( [symbol] → [symbol] ) as the weight functions. The class of all such functions is given by

$${ℱ}_{ABP}^{( n , {n}^{′} )} = \{ f = ( {f}_{1} , … , {f}_{{n}^{′}} ) : {ℤ}_{p}^{n} \to {ℤ}_{p}^{( {n}^{′} )} \vert {f}_{t} ∈ {ℱ}_{ABP}^{( n )} for t ∈ [ {n}^{′} ] \}$$

Thus [symbol] can alternatively be viewed as [symbol] .

Lemma 1 Let ƒ=(V, E, ϕ, v₀, v₁)∈ [symbol] be an ABP of size m and v₀, v₂, . . . , vₘ₋₁, v₁ be stored topologically. Let M be a square matrix of order (m−1) defined by

$$M [ i + 1 , j ] = \{ \begin{matrix}0 , & i < j ; \\ - 1 , & i < j ; \\ 0 , & i < j , {e}_{i , j} = ( {v}_{i} , {v}_{j} ) ∉ E ; \\ ϕ ( {e}_{i , j} ) , & i < j , {e}_{i , j} = ( {v}_{i} , {v}_{j} ) ∈ E .\end{matrix}$$

Then the entries of M are affine in x and ƒ(x)=det(M).

### Functional Encryption for Attribute-Weighted Sum

We formally present the syntax of FE for attribute-weighted sum and define adaptive simulation security of the primitive. We consider the function class [symbol] and message space [symbol] =( [symbol] × [symbol] )*.

Definition 2 (The Attribute-Weighted Sum Functionality) For any n, n′∈ [symbol] the class of attribute-weighted sum functionalities is defined as

$$\{ ( x ∈ {ℤ}_{p}^{n} , z ∈ {ℤ}_{p}^{{n}^{′}} ) ↦ {f ( x )}_{}^{T} z = {\sum }_{t ∈ [ {n}^{′} ]} {f}_{t} ( x ) z [ t ] \vert f = ( {f}_{1} , … , {f}_{{n}^{′}} ) ∈ {ℱ}_{ABP}^{( n , {n}^{′} )} \}$$

Definition 3 (Functional Encryption for Attribute-Weighted Sum) An unbounded-slot FE for attribute-weighted sum associated to the function class [symbol] and the message space [symbol] consists of four PPT algorithms defined as follows:
Setup(1^{λ}, 1ⁿ, 1^{n′}) The setup algorithm takes as input a security parameter A along with two positive integers n, n′ representing the lengths of message vectors. It outputs the master secret-key MSK and the master public-key MPK.
KeyGen(MSK, ƒ) The key generation algorithm takes as input MSK and a function ƒ∈ [symbol] . It outputs a secret-key SK_{ƒ} and make ƒ available publicly.
Enc(MPK, (xᵢ, zᵢ)_{i∈[N]}) The encryption algorithm takes as input MPK and a message (xᵢ, zᵢ)_{i∈[N]}∈( [symbol] × [symbol] )*. It outputs a ciphertext CT and make (xᵢ)_{i∈[N]} available publicly.
Dec((SK_{ƒ}, ƒ), (CT, (xᵢ)_{i∈[N]})) The decryption algorithm takes as input SK_{ƒ} and CT along with ƒ and (xᵢ)_{i∈[N]}. It outputs a value in [symbol] .

Correctness The unbounded-slot FE for attribute-weighted sum is said to be correct if for all (xᵢ, zᵢ)_{iE[N]}∈( [symbol] × [symbol] )* and ƒ∈ [symbol] _{ABP}^{(n,n′)}, we get

$$Pr [ \begin{matrix}\begin{matrix}Dec ( ( {SK}_{f} , f ) , ( CT , {( {x}_{i} )}_{i ∈ [ N ]} ) ) = \\ {\sum }_{i ∈ [ N ]} f {( {x}_{i} )}^{T} {z}_{i} :\end{matrix} & \begin{matrix}( MSK , MPK ) ← \\ Setup ( {1}^{λ} , {1}^{n} , {1}^{{n}^{′}} ) , \\ {SK}_{f} ← KeyGen ( MSK , f ) , \\ CT ← Enc ( MPK , {( {x}_{i} , {z}_{i} )}_{i ∈ [ N ]} )\end{matrix}\end{matrix} ] = 1$$

We consider adaptively simulation-based security of FE for attribute-weighted sum.

Definition 4 Let (Setup, KeyGen, Enc, Dec) be an unbounded-slot FE for attribute-weighted sum for function class [symbol] and message space [symbol] . The scheme is said to be (Qₚᵣₑ, Q_{CT}, Qₚₒₛₜ)-adaptively simulation secure if for any PPT adversary [symbol] making at most Q_{CT} ciphertext queries and Qₚᵣₑ, Qₚₒₛₜ secret key queries before and after the ciphertext queries respectively, we have

$${Expt}_{𝒜}^{Real , ubdFE} ( {1}^{λ} ) {\approx }^{c} {Expt}_{𝒜}^{Ideal , ubdFE} ( {1}^{λ} ) ,$$

where the experiments are defined as follows. Also, an unbounded-slot FE for attribute-weighted sums is said to be (poly, Q_{CT}, poly)-adaptively simulation secure if it is (Qₚᵣₑ, Q_{CT}, Qₚₒₛₜ)-adaptively simulation secure as well as Qₚᵣₑ and Qₚₒₛₜ are unbounded polynomials in the security parameter λ.

| [symbol] | |
|---|---|
| 1. 1^{N} ← [symbol] (1^{λ}); | |
| 2. (MSK, MPK) ← Setup(1^{λ}, 1ⁿ, 1^{n′}); | |
| 3. ((xᵢ*, zᵢ*)_{i∈[N]}) ← [symbol] (MPK); | |
| 4. CT* ← Enc(MPK, (xᵢ*, zᵢ*)_{i∈[N]}); | |
| 5. return [symbol] (MPK, CT*) | |
| [symbol] | |
| 1. 1^{N} ← [symbol] (1^{λ}) | |
| 2. (MSK*, MPK) ← Setup*(1^{λ}, 1ⁿ, 1^{n′}, 1^{N}); | |
| $3. ( {( {x}_{i}^{*} , {z}_{i}^{*} )}_{i ∈ [ N ]} ) ← {A}^{{𝒪}_{KeyG e {n}_{0}^{*} ( {MSK}^{*} , \cdot )}} ( MPK )$ | |
| 4. CT* ← Enc*(MPK, MSK*, (xᵢ*)_{i∈[N]}, [symbol] ); | |
| $5. return {A}^{{𝒪}_{KeyG e {n}_{1}^{*} ( {MSK}^{*} , {( {x}_{i}^{*} )}_{i ∈ [ N ]} , \cdot , \cdot )}} ( MPK , {CT}^{*} )$ | |
| [symbol] _{KeyGen(MSK,·)} | |
| 1. input: f | |
| 2. output: SK_{f} | |
| [symbol] _{KeyGen}_{₀}_{*(MSK*,·)} | |
| 1. input: f_{q} for q ∈ [Qₚᵣₑ] | |
| 2. output: SK_{f}_{_{q}}* | |
| Enc* (MPK, MSK*, (xᵢ*)_{i∈[N]}, ·) | |
| 1. input: | |
| [symbol] | = |
| $\{ ( ( {f}_{q} , {SK}_{{f}_{q}} ) , {\sum }_{i ∈ [ N ]} {{f}_{q} ( {x}_{i}^{*} )}^{T} {z}_{i}^{*} )$ | : |

```
    q ∈ [Qₚᵣₑ]}
  2. output: CT* [symbol]
_{KeyGen*}_{₁}_{(MSK*,(x}_{ᵢ}_{*)}_{_{i∈[N]}}_{,·,·)}
  $1. input : {f}_{q} , {\sum }_{i ∈ [ N ]} {{f}_{q} ( {x}_{i}^{*} )}^{T} {z}_{i}^{*} for q > {𝒬}_{pre}$
2. output: SK*_{f}_{_{q}}
```

### Function-Hiding Slotted Inner Product Functional Encryption

A slotted inner product functional encryption (slotted IPFE) is a hybrid variant of secret-key and public-key IPFE. More specifically, the index set S of the vectors is partitioned into two sets S_{pub} containing public slots and Sₚᵣᵢᵥ containing the private slots. While computing secret-keys, the slotted IPFE encodes elements of the vector in public/private slots using the master secret-key, similar to the case of secret-key IPFE. However, the encryption procedure is only allowed to encode vector elements in the public slots using master public-key as is the case for public-key IPFE. It has been demonstrated that slotted IPFE lets us use the dual system encryption techniques during the security analysis of the cryptographic constructions built from it. We consider the definition of slotted IPFE with respect to some pairing group, that is, all the vectors and inner products in the scheme are encoded in the exponent of the underlying pairing group.

Definition 5 (Slotted Inner Product Functional Encryption) Let G=( [symbol] , [symbol] , [symbol] , g₁, g₂, e) be a tuple of pairing groups of prime order p. A slotted inner product functional encryption (IPFE) scheme based on G consists of 5 efficient algorithms:
IPFE.Setup(1^{λ}, S_{pub}, Sₚᵣᵢᵥ) The setup algorithm takes as input a security parameter A and two disjoint index sets, the public slot S_{pub} and the private slot Sₚᵣᵢᵥ. It outputs the master secret-key IPFE.MSK and the master public-key IPFE.MPK. Let S=S_{pub}∪Sₚᵣᵢᵥ be the whole index set and |S|, |S_{pub}|, |Sₚᵣᵢᵥ| denote the number of indices in S, S_{pub} and Sₚᵣᵢᵥ respectively.
IPFE.KeyGen(IPFE.MSK, [symbol] ) The key generation algorithm takes as input IPFE.MSK and a vector [symbol] ∈ [symbol] It outputs a secret-key IPFE.SK for v∈ [symbol] .
IPFE.Enc(IPFE.MSK, [symbol] ) The encryption algorithm takes as input IPFE.MSK and a vector [symbol] ∈ [symbol] . It outputs a ciphertext IPFE.CT for u∈ [symbol] .
IPFE.Dec(IPFE.SK, IPFE.CT) The decryption algorithm takes as input a secret-key IPFE.SK and a ciphertext IPFE.CT. It outputs an element from [symbol] .
IPFE.SlotEnc(IPFE.MPK, [symbol] ) The slot encryption algorithm takes as input IPFE.MPK and a vector [symbol] ∈ [symbol] . It outputs a ciphertext IPFE.CT for (u∥0_{|S}_{ₚᵣᵢᵥ}_{|))∈} [symbol] _{.}

Correctness The correctness of a slotted IPFE scheme requires the following two properties.
Decryption Correctness: The slotted IPFE is said to satisfy decryption correctness if for all u, v∈ [symbol] , we have

$$Pr [ \begin{matrix}\begin{matrix}Dec ( IPFE . SK , IPFE . CT ) = \\ {〚 v \cdot u 〛}_{T} :\end{matrix} & \begin{matrix}( IPFE . MSK , IPFE . MPK ) ← \\ Setup ( {1}^{λ} , {S}_{pub} , {S}_{priv} ) , \\ IPFE . SK ← \\ KeyGen ( IPFE . MSK , {〚 v 〛}_{2} ) , \\ IPFE . CT ← \\ Enc ( IPFE . MSK , {〚 u 〛}_{1} )\end{matrix}\end{matrix} ] = 1$$

Slot-Mode Correctness: The slotted IPFE is said to satisfy the slot-mode correctness if for all vectors u∈ [symbol] , we have

$$\{ \begin{matrix}( IPFE . MSK , IPFE . MPK , IPFE . CT ) : & \begin{matrix}\begin{matrix}\begin{matrix}( IPFE . MSK , IPFE . MPK ) ← \\ Setup ( {1}^{λ} , {S}_{pub} , {S}_{priv} ) ,\end{matrix} \\ IPFE . CT ←\end{matrix} \\ Enc ( IPFE . MSK , {〚 u \vert \vert {0}_{\vert {S}_{priv} \vert} 〛}_{1} )\end{matrix}\end{matrix} \} ,$$

$$≡ \{ \begin{matrix}( IPFE . MSK , IPFE . MPK , IPFE . CT ) : & \begin{matrix}\begin{matrix}\begin{matrix}( IPFE . MSK , IPFE . MPK ) ← \\ Setup ( {1}^{λ} , {S}_{pub} , {S}_{priv} ) ,\end{matrix} \\ IPFE . CT ←\end{matrix} \\ SlotEnc ( IPFE . MPK , {〚 u 〛}_{1} )\end{matrix}\end{matrix} \}$$

Security Let (IPFE.Setup, IPFE.KeyGen, IPFE.Enc, IPFE.Dec, IPFE.SlotEnc) be a slotted IPFE. The scheme is said to be adaptively function-hiding secure if for all PPT adversary [symbol] , we have

$${Expt}_{𝒜}^{FH - IPFE} ( {1}^{λ} , 0 ) {\approx }^{c} {Expt}_{𝒜}^{FH - IPFE} ( {1}^{λ} ) ,$$

where the experiment [symbol] (1^{λ}, b) for b∈{0, 1} is defined as follows:

[symbol]

| [symbol] | |
|---|---|
| 1. (S_{pub}, Sₚᵣᵢᵥ) ← [symbol] (1^{λ}); | ← |

```
  2. (IPFE.MSK, IPFE.MPK)
    Setup(1^{λ}, S_{pub}, Sₚᵣᵢᵥ);
  $3. return {A}^{{𝒪}_{{KeyGen}_{b}} ( \cdot , \cdot ) , {𝒪}_{{Enc}_{b}} ( \cdot , \cdot )} ( IPFE . MPK ) if$
    vⱼ⁰|_{S}_{_{pub}} = vⱼ¹|_{S}_{_{pub}} and vⱼ⁰ · uᵢ⁰ = vⱼ¹ · uᵢ¹ for
    all { [symbol] vⱼ⁰ [symbol] ₂, [symbol]  vⱼ¹ [symbol] ₂}ⱼ, { [symbol] uᵢ⁰ [symbol] ₁, [symbol]  uᵢ¹ [symbol] ₁}ᵢ queried
    by [symbol]   to [symbol]  _{KeyGen}_{_{b}}(·, ·) and [symbol] _{Enc}_{_{b}} (·, ·) respectively, [symbol]
_{KeyGen}_{_{b}}(·, ·):
  1. input: [symbol]  vⱼ⁰ [symbol] ₂, [symbol]  vⱼ¹ [symbol] ₂ ∈ [symbol] ₂^{|S|}
  2. output
    IPFE.SKⱼ ← KeyGen(IPFE.MSK, [symbol]  vⱼ^{b} [symbol] ₂) [symbol]
_{Enc}_{_{b}} (·, ·):
  1. input: [symbol]  uᵢ⁰ [symbol] ₁, [symbol]  uᵢ¹ [symbol] ₁ ∈ [symbol] ₁^{|S|}
  2. output
    IPFE.CTᵢ ← Enc(IPFE.MSK, [symbol]  uᵢ^{b} [symbol] ₁)
```

where vⱼ|S_{pub} represents the elements of vⱼ sitting at the indices in S_{pub}.

Lemma 2 Let G=( [symbol] , [symbol] , [symbol] , g₁, g₂, e) be a tuple of pairing groups of prime order p and k≥1 an integer constant. If MDDHₖ holds in both groups [symbol] , [symbol] , then there is an adaptively function-hiding secure IPFE scheme based on G.

### Arithmetic Key Garbling Scheme

Prior work introduced arithmetic key garbling scheme (AKGS). The notion of AKGS is an information theoretic primitive, inspired by randomized encodings and partial garbling schemes. It garbles a function ƒ: [symbol] → [symbol] (possibly of size (m+1)) along with two secrets z,β∈ [symbol] and produces affine label functions L₁, . . . , Lₘ₊₁: [symbol] → [symbol] . Given ƒ, an input x∈ [symbol] and the values L₁(x), . . . , Lₘ₊₁(x), there is an efficient algorithm which computes zƒ(x)+β without revealing any information about z and β.

Definition 6 (Arithmetic Key Garbling Scheme (AKGS)) An arithmetic garbling scheme (AKGS) for a function class [symbol] ={ƒ}, where ƒ: [symbol] → [symbol] , consists of two efficient algorithms:
Garble(zƒ(x)+β) The garbling is a randomized algorithm that takes as input a description of the function zƒ(x)+β with ƒ∈ [symbol] and scalars z,β∈ [symbol] where z,x are treated as variables. It outputs (m+1) affine functions L₁, . . . , Lₘ₊₁: [symbol] → [symbol] which are called label functions that specifies how input is encoded as labels. Pragmatically, it outputs the coefficient vectors [symbol] , . . . , [symbol] .
Eval(ƒ, x, [symbol] , . . . , [symbol] ) The evaluation is a deterministic algorithm that takes as input a function ƒ∈ [symbol] an input vector x∈ [symbol] and integers [symbol] , . . . , [symbol] ∈ [symbol] which are supposed to be the values of the label functions at (x,z). It outputs a value in [symbol] .

Correctness The AKGS is said to be correct if for all ƒ: [symbol] → [symbol] ∈ [symbol] , z, β∈ [symbol] and x∈ [symbol] , we have

$$Pr [ \begin{matrix}\begin{matrix}Eval ( f , x , {ℓ}_{1} , … , {ℓ}_{m + 1} ) = \\ z f ( x ) + β :\end{matrix} & \begin{matrix}( {ℓ}_{1} , … , {ℓ}_{m + 1} ) ← \\ Garble ( zf ( x ) + β ) , \\ {ℓ}_{j} ← {L}_{j} ( x , z ) for j ∈ [ m + 1 ]\end{matrix} ] = 1\end{matrix}$$

The scheme have deterministic shape, meaning that m is determined solely by ƒ, independent of z,β and the randomness in Garble. The number of label functions, (m+1), is called the garbling size of ƒ under this scheme.

Linearity The AKGS is said to be linear if the following conditions hold:
Garble(zƒ(x)+β) uses a uniformly random vector r← [symbol] as its randomness, where m′ is determined solely by ƒ, independent of z,β.
The coefficient vectors [symbol] , . . . , [symbol] produced by Garble(zƒ(x)+β) are linear in (z,β,r).
Eval(ƒ, x, [symbol] , . . . , [symbol] ) is linear in [symbol] , . . . , [symbol] .

Simulation-Based Security Herein, we consider linear AKGS for our application. Now, we state the usual simulation-based security of AKGS, which is similar to the security of partial garbling scheme.

An AKGS=(Garble, Eval) for a function class [symbol] is secure if there exists an efficient algorithm SimGarble such that for all ƒ: [symbol] → [symbol] , z, β∈ [symbol] and x∈ [symbol] , the following distributions are identically distributed:

$$\{ ( {ℓ}_{1} , … , {ℓ}_{m + 1} ) : \begin{matrix}( {ℓ}_{1} , … , {ℓ}_{m + 1} ) ← Garble ( zf ( x ) + β ) , \\ {ℓ}_{j} ← {L}_{j} ( x , z ) for j ∈ [ m + 1 ]\end{matrix} \} ,$$

$$\{ ( , … , {+ 1}_{} ) : ( , … , {+ 1}_{} ) ← SimGarble ( f , x , zf ( x ) + β ) \}$$

The simulation security of AKGS is used to obtain semi-adaptive or selective security of FE for attribute-weighted sum, however it is not sufficient for achieving adaptive security. We consider the piecewise security of AKGS where it was used to get adaptive security for ABE.

Definition 7 (Piecewise Security of AKGS) An AKGS=(Garble, Eval) for a function class [symbol] is piecewise secure if the following conditions hold:
The first label value is reversely sampleable from the other labels together with ƒ and x. This reconstruction is perfect even given all the other label functions. Formally, there exists an efficient algorithm RevSamp such that for all ƒ: [symbol] → [symbol] ∈ [symbol] , z, β∈ [symbol] and x∈ [symbol] the following distributions are identical:

$$\{ ( {ℓ}_{1} , {ℓ}_{2} , … , {ℓ}_{m + 1} ) : \begin{matrix}( {ℓ}_{1} , … , {ℓ}_{m + 1} ) ← Garble ( zf ( x ) + β ) , \\ {ℓ}_{1} ← {L}_{j} ( x , z )\end{matrix} \} ,$$

$$\{ ( {ℓ}_{1} , {ℓ}_{2} , … , {ℓ}_{m + 1} ) : \begin{matrix}( {ℓ}_{1} , … , {ℓ}_{m + 1} ) ← Garble ( zf ( x ) + β ) , \\ {ℓ}_{j} ← {L}_{j} ( x , z ) for j ∈ [ 2 , m + 1 ] , \\ {ℓ}_{1} ← RevSamp ( f , x , zf ( x ) + β , {ℓ}_{2} , … , {ℓ}_{m + 1}\end{matrix} \}$$

For the other labels, each is marginally random even given all the label functions after it. Formally, this means for all ƒ: [symbol] → [symbol] ∈ [symbol] , z, β∈ [symbol] , x∈ [symbol] and all j∈[2, m+1], the following distributions are identical:

$$\{ ( {ℓ}_{j} , {ℓ}_{j + 1} , … , {ℓ}_{m + 1} ) : \begin{matrix}( {ℓ}_{1} , … , {ℓ}_{m + 1} ) ← Garble ( zf ( x ) + β ) , \\ {ℓ}_{j} ← {L}_{j} ( x , z )\end{matrix} \} ,$$

$$\{ ( {ℓ}_{j} , {ℓ}_{j + 1} , … , {ℓ}_{m + 1} ) : \begin{matrix}( {ℓ}_{1} , … , {ℓ}_{m + 1} ) ← Garble ( zf ( x ) + β ) , \\ {ℓ}_{j} ← {ℤ}_{p}\end{matrix} \}$$

Lemma 3 A piecewise secure AKGS=(Garble, Eval) for a function class [symbol] is also simulation secure.

We now define special structural properties of AKGS, related to the piecewise security of it.

Definition 8 (Special Piecewise Security of AKGS) An AKGS(Garble, Eval) for a function class [symbol] is special piecewise secure if for any ƒ: [symbol] → [symbol] ∈ [symbol] , z, β∈ [symbol] and x∈ [symbol] it has the following special form:
The first label value [symbol] is always non-zero, i.e., Eval(ƒ, x, 1, 0, . . . , 0)≠0 where we take [symbol] =1 and [symbol] =0 for 1<j≤(m+1).
Let r← [symbol] be the randomness used in Garble(zƒ(x)+0). For all j∈[2, m+1]. the label function Lⱼ produced by Garble(zƒ(x)+β; r) can be written as

$${L}_{j} ( x ) = {k}_{j} r [ j - 1 ] + {L}_{j}^{′} ( x ; z , β , r [ j ] , r [ j + 1 ] , … , r [ {m}^{′} ] )$$

where kⱼ∈ [symbol] is a non-zero constant (not depending on x, z, β, r) and L′ⱼ is an affine function of x whose coefficient vector is linear in (z, β, r[j], r[j+1], . . . , r[m′]). The component r[j−1] is called the randomizer of Lⱼ and [symbol] .

Lemma 4 A special piecewise secure AKGS=(Garble, Eval) for a function class [symbol] is also piecewise secure. The RevSamp algorithm (required in piecewise security) obtained for a special piecewise secure AKGS is linear in γ, [symbol] , . . . , [symbol] and perfectly recovers [symbol] even if the randomness of Garble is not uniformly sampled. More specifically, we have the following:

$$Eval ( f , x , {ℓ}_{1} , … , {ℓ}_{m + 1} ) = {ℓ}_{1} Eval ( f , x , 1 , 0 , … , 0 ) + Eval ( f , x , 0 , {ℓ}_{2} , … , {ℓ}_{m + 1} ) \qquad ( 7 )$$

$$RevSamp ( f , x , γ , {ℓ}_{2} , … , {ℓ}_{m + 1} ) = {( Eval ( f , x , 1 , 0 , … , 0 ) )}^{- 1} ( γ - Eval ( f , x , 0 , {ℓ}_{2} , … , {ℓ}_{m + 1} ) ) \qquad ( 8 )$$

Note that, equation 7 follows from the linearity of Eval and equation 8 ensures that RevSamp perfectly computes [symbol] (which can be verified by equation 7 with γ=zƒ(x)+β).

Lemma 5 A piecewise secure AKGS=(Garble, Eval) is also special piecewise secure after an appropriate change of variable for the randomness used by Garble.

Instantiation of AKGS. We now discuss an instantiation of AKGS=(Garble, Eval) for the function class [symbol] = [symbol] .

Garble(zƒ(x)+β) It takes input an ABP ƒ: [symbol] → [symbol] ∈ [symbol] of size (m+1) and two secrets z, β∈ [symbol] . The algorithm works as follows:
1. Using Lemma 1, it computes a matrix M∈ [symbol] such that det(M) is the output of the function ƒ.
2. Next, it augments M into an (m+1)×(m+1) matrix M′:

$$( \begin{matrix}\begin{matrix}* & * & … & * & * \\ - 1 & * & … & * & * \\ & - 1 & … & * & * \\ & & ⋱ & ⋮ & ⋮ \\ 0 & & & - 1 & *\end{matrix} & \begin{matrix}β \\ 0 \\ 0 \\ ⋮ \\ 0\end{matrix} \\ \begin{matrix}0 & & 0 & … & 0 & - 1\end{matrix} & z\end{matrix} ) = ( \begin{matrix}\begin{matrix}M\end{matrix} & {m}_{1} \\ {m}_{2}^{T} & z\end{matrix} )$$

3. It samples its randomness r← [symbol] and sets

$$N = ( \begin{matrix}{I}_{m} & r \\ 0 & 1\end{matrix} ) .$$

4. Finally, it defines the label functions by computing

$$\hat{M} = {M}^{′} N = ( \begin{matrix}M & Mr + {m}_{1} \\ {m}_{2}^{T} & {m}_{2}^{T} r + z\end{matrix} ) = ( \begin{matrix}\begin{matrix} & & & & & & & \\ & & & & & & & \\ & & & & M & & & \\ & & & & & & & \end{matrix} & \begin{matrix}{L}_{1} ( x ) \\ {L}_{2} ( x ) \\ ⋮ \\ {L}_{m} ( x )\end{matrix} \\ \begin{matrix}0 & 0 & … & 0 & - 1\end{matrix} & {L}_{m + 1} ( z )\end{matrix} )$$

and outputs the coefficient vectors [symbol] , . . . , [symbol] of L₁ . . . , Lₘ₊₁.

Remark 1 We note down some structural properties of Garble as follows:
The label function Lⱼ for every j∈[m] is an affine function of the input x and Lₘ₊₁ is an affine function of z. It follows from the fact that M′ is affine in x,z and N is independent of x,z. Hence, the last column of the product M′N, which is the label functions L₁, . . . , Lₘ₊₁, are affine in x,z.
The output size of Garble is determined solely by the size of ƒ (as an ABP), hence Garble has deterministic shape.
Note that Garble is linear in (z,β,r), i.e., the coefficient vectors [symbol] , . . . , [symbol] are linear in (z,β,r). It follows from the fact that M, m₂ are independent of (z,β,r), and r, m₁, z are linear in (z,β,r). Hence, Mr+m₁, which defines the label functions L₁, . . . , Lₘ, and m₂^{T}r+z, which is the label function Lₘ₊₁, are linear in (z,β,r).
The last label function Lₘ₊₁ is in a special form, meaning that it is independent of x, β and r[j<m]. In particular, it takes the form Lₘ=m₂^{T}r+z=z−r[m]. Thus, the elements of the coefficient vector [symbol] are all zero except the constant term, i.e., [symbol] [const]=z−r[m] and [symbol] [coef₂]=0 for all i∈[n].

Eval(ƒ, x, [symbol] , . . . , [symbol] ) It takes input an ABP ƒ: [symbol] → [symbol] ∈ [symbol] of size (m+1), an input x∈ [symbol] and (m+1) labels [symbol] , . . . , [symbol] . It proceeds as follows:
1. It computes the matrix M using Lemma 1 after substituting x.
2. Next, it augments M to get the matrix

$$\hat{M} = ( \begin{matrix}\begin{matrix} & & & & & & & \\ & & & & & & & \\ & & & & M & & & \\ & & & & & & & \end{matrix} & \begin{matrix}{ℓ}_{1} \\ {ℓ}_{2} \\ ⋮ \\ {ℓ}_{m}\end{matrix} \\ \begin{matrix}0 & 0 & … & 0 & - 1\end{matrix} & {ℓ}_{m + 1}\end{matrix} )$$

3. It returns det(\hat{M}).

For correctness of the evaluation procedure, we see that when [symbol] =Lⱼ(x) for all j∈[m] and [symbol] =Lₘ₊₁(z), Eval computes

$$det ( \hat{M} ) = det ( {M}^{′} N ) = det ( {M}^{′} ) det ( N ) = det ( {M}^{′} ) = z det ( M ) + β = zf ( x ) + β .$$

The determinant of M′ is calculated via Laplace expansion in the last column.

Remark 2 Here, we observe some structural properties of Eval which we require for our application.
If we consider the Laplace expansion of det(\hat{M}) in the last column then Eval can be written as

$$Eval ( f , x , {ℓ}_{1} , … , {ℓ}_{m + 1} ) = {A}_{1} {ℓ}_{1} + {A}_{2} {ℓ}_{2} + … + {A}_{m + 1} {ℓ}_{m + 1} \qquad ( 9 )$$

where Aⱼ is the (j, (m+1))-cofactor of \hat{M}. This shows that Eval is linear in [symbol] , . . . , [symbol] . Due to this linearity feature, Eval can be computed in the exponent of any bilinear group. More precisely, suppose G=( [symbol] , [symbol] , [symbol] , g₁, g₂, e) be a bilinear group then for any i∈{1, 2, T}, we have Eval(ƒ, x, [symbol] , . . . , [symbol] )= [symbol] Eval(ƒ, x, [symbol] , . . . , [symbol] .
Now, in particular, the coefficient of [symbol] is A₁=(−1)^{2+m}(−1)^{m=1}. Therefore, for any non-zero δ∈ [symbol] , we can write

$$\begin{matrix}δ + Eval ( f , x , {ℓ}_{1} , … , {ℓ}_{m + 1} ) & = & \begin{matrix}Eval ( f , x , δ , 0 , … , 0 )\end{matrix} + & ( 10 ) \\ & & Eval ( f , x , {ℓ}_{1} , … , {ℓ}_{m + 1} ) & \\ & = & Eval ( f , x , {ℓ}_{1} + δ , {ℓ}_{2} , … , {ℓ}_{m + 1} ) & ( 11 )\end{matrix}$$

where equation 10 holds due to equation 9 and A₁=1; and equation 11 holds by the linearity of Eval. We will utilize equation 11 in our extended one slot FE construction.

Now, we describe the simulator of AKGS which simulates the values of label functions by using ƒ, x and zƒ(x)+β.

SimGarble(ƒ, x, zƒ(x)+β) The simulator works as follows:
1. It defines a set

$$H = \{ ( \begin{matrix}{I}_{m} & r \\ 0 & 1\end{matrix} ) \vert r ∈ {ℤ}_{p}^{m} \}$$

which forms a matrix subgroup.
2. Following Lemma 1, it computes the matrix M using ƒ, x and sets the matrix

$${M}^{″} = ( \begin{matrix}\begin{matrix} & & & & & & & \\ & & & & & & & \\ & & & & M & & & \\ & & & & & & & \end{matrix} & \begin{matrix}zf ( x ) + β \\ 0 \\ ⋮ \\ 0\end{matrix} \\ \begin{matrix}0 & 0 & … & 0 & - 1\end{matrix} & 0\end{matrix} )$$

which defines a left coset M″H={M″N|N∈H}.
3. It uniformly samples a random matrix from the coset M″H and returns the last column of the matrix as simulated values of the label functions.

Lemma 6 The above construction of AKGS=(Garble, Eval) is secure. Moreover, it is special piecewise secure as per Definition 8.

### 1-Key 1-Ciphertext Secure One-Slot FE for Attribute-Weighted Sums

In this section, we first describe a private-key one-slot FE scheme for the attribute-weighted sum functionality that is proven simulation secure against a single ciphertext query and a single secret key query either before or after the ciphertext query. This scheme would be crucially embedded into the hidden slots for our full-fledged public-key one-slot FE scheme for attribute-weighted sums presented in the next section. We describe the construction for any fixed value of the security parameter A and suppress the appearance of λ for simplicity of notations. Let Garble, Eval) be a special piecewise secure AKGS for a function class [symbol] , G= [symbol] , [symbol] , [symbol] , g₁, g₂, e) a tuple of pairing groups of prime order p, and (SK-IPFE.Setup.SK-IPFE.KeyGen, SK-IPFE.Enc, SK-IPFE.Dec) a secret-key function-hiding SK-IPFE based on G.

Setup(1ⁿ, 1^{n′}) Define the index sets as follows

$${S}_{1 - FE} = \{ const , {\{ {coef}_{i} \}}_{i ∈ [ n ]} , {\{ {sim}_{τ} , {sim}_{τ}^{*} \}}_{τ ∈ [ {n}^{′} ]} \} ,$$

$${\hat{S}}_{1 - FE} \{ , , \}$$

It generates IPFE.MSK←SK-IPFE.Setup(S_{1-FE}) and [symbol] ←SK-IPFE.Setup(S_{1-FE}). Finally, it returns MSK=(IPFE.MSK, [symbol] ).

KeyGen(MSK, ƒ) Let ƒ∈ [symbol] be a function such that ƒ=(ƒ₁, . . . , ƒₙ): [symbol] × [symbol] → [symbol] where ƒ₁, . . . , ƒ_{n′}: [symbol] → [symbol] are ABPs of size (m+1). Sample βₜ← [symbol] for t∈[n′] such that Σ_{t∈[n′]}βₜ=0 mod p. Next, sample independent random vectors rₜ← [symbol] for garbling and compute the coefficient vectors

$$( {ℓ}_{1 , t} , … , {ℓ}_{m , t} , {ℓ}_{m + 1 , t} ) ← Garble ( z [ t ] {f}_{t} ( x ) + {β}_{t} ; {r}_{t} )$$

for all t∈[n′]. Here we make use of the instantiation of the AKGS described herein. From the description of that AKGS instantiation, we note that the (m+1)-th label function [symbol] would be of the form [symbol] =z[t]−rₜ[m]. Also all the label functions [symbol] , . . . , [symbol] involve only the variables x and not the variable z[t]. Next, for all j∈[m] and t∈[n′], it defines the vectors v_{j,t} corresponding to the label functions [symbol] obtained from the partial garbling:

| vector | const | coefᵢ | sim_{T} | sim_{T}* |
|---|---|---|---|---|
| υ_{j,t} | [symbol] [const] | [symbol] [coefᵢ] | 0 | 0 |
| | vector | [symbol] | [symbol] | [symbol] |
| | υ_{m+1,t} | rₜ[m] | 1 | 0 |

It generates the secret-keys as

$$IPFE . {SK}_{j , t} ← SK - IPFE . KeyGen ( IPFE . MSK , {v}_{j , t} {2}_{} ) \qquad for j ∈ [ m ] , t ∈ [ {n}^{′} ]$$

$$← SK - IPFE . KeyGen ( , {v}_{m + 1 , t} {2}_{} ) \qquad for t ∈ [ {n}^{′} ]$$

It returns the secret-key as SK_{ƒ}=({IPFE.SK_{j,t}}_{j∈[m],t∈[n′]}, { [symbol] }_{t∈[n′]}).

Enc(MSK, x∈ [symbol] , z∈ [symbol] ) It sets the vectors

| vector | const | coefᵢ | sim_{T} | sim_{T}* |
|---|---|---|---|---|
| u | 1 | x[i] | 0 | 0 |
| | vector | [symbol] | [symbol] | [symbol] |
| | hₜ | −1 | z[t] | 0 |

for all t∈[n′]. It encrypts the vectors as

$$IPFE . CT ← SK - IPFE . Enc ( IPFE . MSK , u {1}_{} )$$

$$← SK - IPFE . Enc ( , {h}_{t} {1}_{} ) \qquad for t ∈ [ {n}^{′} ]$$

and returns the ciphertext as CT=(IPFE.CT, { [symbol] }_{t∈[n′]}).

Dec SK_{ƒ}, ƒ), (CT, x)) It parses the secret-key SK_{ƒ}=({IPFE.SK_{j,t}}_{j∈[m],t∈[n′]}, { [symbol] }_{t∈[n′]}) and the ciphertext CT=(IPFE.CT, { [symbol] }_{t∈[n′]}). It uses the decryption algorithm of SK-IPFE to compute

$${ℓ}_{j , t} {T}_{} = SK - IPFE . Dec ( IPFE . {SK}_{j , t} , IPFE . CT ) \qquad for j ∈ [ m ] , t ∈ [ {n}^{′} ]$$

$${ℓ}_{m + 1 , t} {T}_{} = SK - IPFE . Dec ( , ) \qquad for t ∈ [ {n}^{′} ]$$

Next, it utilizes the evaluation procedure of AKGS and obtain a combined value

$$ρ {T}_{} = {\prod }_{t ∈ [ {n}^{′} ]} Eval ( {f}_{t} , x , {ℓ}_{1 , t} {T}_{} , … , {ℓ}_{m + 1 , t} {T}_{} ) .$$

Finally, it returns a value ρ by solving a discrete logarithm problem. We assume that the desired attribute-weighted sum lies within a specified polynomial-sized domain so that discrete logarithm can be solved via brute force.

Correctness By the correctness of IPFE, we have SK-IPFE.Dec(IPFE.SK_{j,t}, IPFE.CT)= [symbol] = [symbol] L_{j,t}(x) [symbol] for all j∈[m], t∈[n′] and SK-IPFE.Dec( [symbol] , [symbol] )= [symbol] = [symbol] z[t]−rₜ[m] [symbol] for all t∈[n′]. Next, using the correctness of AKGS and the linearity of the Eval function, we have

$$Eval ( {f}_{t} , x , {ℓ}_{1 , t} {T}_{} , … , {ℓ}_{m + 1 , t} {T}_{} ) = {f}_{t} ( x ) z [ t ] + {β}_{t} {T}_{}$$

Therefore, we get by multiplying

$$\begin{matrix}ρ {T}_{} = {\prod }_{t ∈ [ {n}^{′} ]} Eval ( {f}_{t} , x , {ℓ}_{1 , t} {T}_{} , … , {ℓ}_{m + 1 , t} {T}_{} ) \\ = {\sum }_{t = 1}^{{n}^{′}} Eval ( {f}_{t} , x , {ℓ}_{1 , t} , … , {ℓ}_{m + 1 , t} ) {T}_{} \\ = {\sum }_{t = 1}^{{n}^{′}} {f}_{t} ( x ) z [ t ] + {β}_{t} {T}_{} \\ = {f ( x )}^{T} z {T}_{}\end{matrix}$$

where the last equality holds since Σ_{t∈[n′]}βₜ=0 mod p.

### One-Slot FE for Attribute-Weighted Sums

In this section we present our public-key one-slot FE scheme Πₒₙₑ for the attribute-weighted sum functionality that is proven adaptively simulation secure against a single ciphertext query and an arbitrary polynomial number of secret key queries both before and after the ciphertext query. As outlined in Remark 3 below, this scheme can naturally be extended to one supporting a bounded number of ciphertext queries. We describe the construction for any fixed value of the security parameter A and suppress the appearance of λ for simplicity of notations. Let (Garble, Eval) be a special piecewise secure AKGS for a function class [symbol] , G=( [symbol] , [symbol] , [symbol] , g₁, g₂, e) a tuple of pairing groups of prime order p such that MDDHₖ holds in [symbol] , and (IPFE.Setup.IPFE.KeyGen, IPFE.Enc, IPFE.Dec) a slotted IPFE based on G. We construct an FE scheme for attribute-weighted sums with the message space [symbol] = [symbol] × [symbol] .

Setup(1ⁿ, 1^{n′}) Define the following index sets as follows

$${S}_{pub} = \{ {\{ {const}^{( ι )} \}}_{ι ∈ [ k ]} , {\{ {coef}_{i}^{( ι )} \}}_{ι ∈ [ k ] , i ∈ [ n ]} \} , {\hat{S}}_{pub} = {\{ , \}}_{ι ∈ [ k ]}$$

$${S}_{priv} = \{ const , {\{ {coef}_{i} \}}_{i ∈ [ n ]} , {\{ {sim}_{τ} , {sim}_{τ}^{*} \}}_{τ ∈ [ {n}^{′} ]} \} ,$$

$${\hat{S}}_{priv} = \{ , , , , , , {*}^{} \} .$$

It generates (IPFE.MSK, IPFE.MPK)←IPFE.Setup(S_{pub}, Sₚᵣᵢᵥ) and ( [symbol] , [symbol] ) ← IPFE.Setup(Ŝ_{pub}, Sₚᵣᵢᵥ). Finally, it returns MSK=(IPFE.MSK, [symbol] ) and MPK=(IPFE.MPK,

[symbol]

).

KeyGen(MSK, ƒ) Let ƒ=(ƒ₁, . . . , ƒ_{n′})∈ [symbol] . Sample α,βₜ← [symbol] for t∈[n′] such that

$${\sum }_{t ∈ [ {n}^{′} ]} {β}_{t} [ ι ] = 0 \qquad mod p for all ι ∈ [ k ]$$

Next, sample independent random vectors rₜ^{(ι)}← [symbol] and computes

$$( {ℓ}_{1 , t}^{( ι )} , … , {ℓ}_{m , t}^{( ι )} , {ℓ}_{m + 1 , t}^{( ι )} ) ← Garble ( α [ ι ] z [ t ] {f}_{t} ( x ) + {β}_{t} [ ι ] ; {r}_{t}^{( ι )} )$$

for all ι∈[k], t∈[n′]. Here we make use of the instantiation of the AKGS described herein. From the description of that AKGS instantiation, we note that the (m+1)-th label function [symbol] would be of the form [symbol] =α[ι]z[t]−rₜ^{(ι)}[m] where α[ι] is a constant. Also all the label functions [symbol] , . . . , [symbol] involve only the variables x and not the variable z[t]. Next, for all j∈[m] and t∈[n′], it defines the vectors v_{j,t} corresponding to the label functions [symbol] obtained from the partial garbling above as

| vector | const^{(ι)} | coefᵢ^{(ι)} | Sₚᵣᵢᵥ |
|---|---|---|---|
| υ | α[ι] | 0 | 0 |
| υ_{j, t} | [symbol] [const] | [symbol] [coefᵢ] | 0 |
| vector | [symbol] ^{(ι)} | [symbol] ^{(ι)} | Ŝₚᵣᵢᵥ |
| υ_{m+1, t} | rₜ^{(ι)}[m] | α[ι] | 0 |

It generates the secret-keys as

$$IPFE . SK ← IPFE . KeyGen ( IPFE . MSK , v {2}_{} )$$

$$IPFE . {SK}_{j , t} ← IPFE . KeyGen ( IPFE . MSK , {v}_{j , t} {2}_{} ) \qquad for j ∈ [ m ] , t ∈ [ {n}^{′} ]$$

$$← IPFE . KeyGen ( , {v}_{m + 1 , t} {2}_{} ) \qquad for t ∈ [ {n}^{′} ]$$

It returns SK_{ƒ}=(IPFE.SK, {IPFE.SK_{j,t}}_{j∈[m],t∈[n′]}, { [symbol] }_{t∈[n′]}).

Enc(MPK, x∈ [symbol] , z∈ [symbol] ) It samples s← [symbol] and set the vectors

| vector | const^{(ι)} | coefᵢ^{(ι)} |
|---|---|---|
| u | s[ι] | s[ι]x[i] |
| vector | [symbol] | [symbol] |
| hₜ | −s[ι] | s[ι]z[t] |

for all t∈[n′]. It encrypts the vectors as

$$IPFE . CT ← IPFE . SlotEnc ( IPFE . MPK , u {1}_{} )$$

$$← IPFE . SlotEnc ( , {h}_{t} {1}_{} ) \qquad for t ∈ [ {n}^{′} ]$$

and returns the ciphertext as CT=(IPFE.CT, { [symbol] }_{t∈[n′]}).

Dec((SK_{ƒ}, ƒ), (CT, x)) It parses the secret-key SK_{ƒ}=(IPFE.MSK, {IPFE.MSK_{j,t}}_{j∈[m],t∈[n′]}, { [symbol] }_{t∈[n′]}) and the ciphertext CT=(IPFE.CT, { [symbol] }_{t∈[n′]}). It uses the decryption algorithm of IPFE to compute

$$μ {T}_{} = IPFE . Dec ( IPFE . SK , IPFE . CT )$$

$${ℓ}_{j , t} {T}_{} = IPFE . Dec ( IPFE . {SK}_{j , t} , IPFE . CT ) \qquad for j ∈ [ m ] , t ∈ [ {n}^{′} ]$$

$${ℓ}_{m + 1 , t} {T}_{} = IPFE . Dec ( , ) \qquad for t ∈ [ {n}^{′} ]$$

Next, it utilizes the evaluation procedure of AKGS and obtain a combined value

$$ρ {T}_{} = {\prod }_{t ∈ [ {n}^{′} ]} Eval ( {f}_{t} , x , {ℓ}_{1 , t} {T}_{} , … , {ℓ}_{m + 1 , t} {T}_{} ) .$$

Finally, it returns a value ζ from a polynomially bounded set [symbol] such that [symbol] = [symbol] _{T}· [symbol] ; otherwise ⊥.

Correctness By the correctness of IPFE, AKGS and the linearity of the Eval function we have

$$Eval ( {f}_{t} , x , {ℓ}_{1 , t} {T}_{} , … , {ℓ}_{m + 1 , t} {T}_{} ) = {\sum }_{ι = 1}^{k} α [ ι ] s [ ι ] \cdot {f}_{t} ( x ) z [ t ] + {β}_{t} [ ι ] s [ ι ] {T}_{} = α \cdot s \cdot {f}_{t} ( x ) z [ t ] + {β}_{t} \cdot s {T}_{}$$

Therefore, [symbol] = [symbol] Σₜ₌₁^{n′}α·s·ƒₜ(x)z[t]+βₜ·s [symbol] = [symbol] α·sƒ(x)^{T}z [symbol] since Σ_{t∈[n′]}βₜ[ι]=0 mod p for all ι∈[k]. Also, by the correctness of IPFE we see that [symbol] = [symbol] and hence [symbol] = [symbol] ƒ(x)^{T}z [symbol] ∈ [symbol] .

Remark 3 (Multi-Ciphertext Scheme) The one-slot FE scheme Πₒₙₑ described above is secure against adversaries that are restricted to query a single ciphertext. However, we can easily modify the FE scheme to another FE that is secure for any a-priori bounded number of ciphertext queries from the adversary's end. For the extension, we introduce additional (2n′+²)q_{CT} private slots on each ciphertext and decryption key sides, where q_{CT} denotes the number of ciphertext queries. More specifically, we add 2n′q_{CT} and 2q_{CT} dimensional hidden slots to Sₚᵣᵢᵥ and Ŝₚᵣᵢᵥ respectively to handle the q_{CT} ciphertext queries during the security reduction. Consequently, the sizes of system parameters, secret-keys and ciphertext would grow linearly with q_{CT}. A similar strategy can be followed to convert our extended one-slot FE scheme (described herein) that only supports a single ciphertext query to one that is secure for any a-priori bounded number of ciphertext queries.

### 1-Key 1-Ciphertext Secure One-Slot Extended FE Designed for Bounded-Key One-Slot Extended FE for Attribute-Weighted Sums

In this section, we present a private-key one-slot FE scheme for an extended attribute-weighted sum functionality that is proven simulation secure against a single ciphertext query and a single secret key query either before or after the ciphertext query. This scheme will be embedded into the hidden subspaces of the public-key multi-key FE scheme for the same functionality presented in the next section in its security proof. We describe the construction for any fixed value of the security parameter λ and suppress the appearance of λ for simplicity of notations. Let (Garble, Eva) be a special piecewise secure AKGS for a function class [symbol] , G=( [symbol] , [symbol] , [symbol] , g₁, g₂, e) a tuple of pairing groups of prime order p, and (IPFE.Setup, IPFE.KeyGen, IPFE.Enc, IPFE.Dec) a secret-key function-hiding SK-IPFE based on G.

Setup(1^{λ}, 1ⁿ, 1^{n′}) Define the following index sets as follows

S_{1-extFE}={const,{coefᵢ}_{i∈[n]},{extnd_{κ}}_{κ∈[k]},query,{sim_{τ},sim_{τ}*}_{τ∈[n′]}},

Ŝ_{1-extFE}={ [symbol] , [symbol] , [symbol] }

It generates two IPFE master secret-keys IPFE.MSK←SK-IPFE.Setup(S_{1-extFE}) and [symbol] ←SK-IPFE.Setup(Ŝ_{1-extFE}). Finally, it returns MSK=(IPFE.MSK, [symbol] ).

KeyGen(MSK, (ƒ,y)) Let ƒ=(ƒ₁, . . . , ƒ_{n′})∈ [symbol] and y∈ [symbol] . Samples integers νₜ, βₜ← [symbol] for t∈[n′] such that

$${\sum }_{t ∈ [ {n}^{′} ]} {v}_{t} = 1 and {\sum }_{t ∈ [ {n}^{′} ]} {β}_{t} = 0 modulo p .$$

Next, samples independent random vectors rₜ← [symbol] for garbling and computes the coefficient vectors

$$( {ℓ}_{1 , t} , … , {ℓ}_{m , t} , {ℓ}_{m + 1 , t} ) ← Garble ( z [ t ] {f}_{t} ( x ) + {β}_{t} ; {r}_{t} )$$

for each t∈[n′]. Here we make use of the instantiation of the AKGS described in Section. From the description of that AKGS instantiation, we note that the (m+1)-th label function [symbol] would be of the form [symbol] =z[t]−rₜ[m]. Also all the label functions [symbol] , . . . , [symbol] involve only the variables x and not the variable z[t]. Next, for all j∈[m] and t∈[n′], it defines the vectors v_{j,t} corresponding to the label functions [symbol] obtained from the partial garbling above and the vector y as

| vector | const | coefᵢ | extnd_{κ} | query | sim_{τ} | sim_{τ}* |
|---|---|---|---|---|---|---|
| v_{1, t} | [symbol] [const] | [symbol] [coefᵢ] | y[κ]νₜ | 0 | 0 | 0 |
| v_{j, t} | [symbol] [const] | [symbol] [coefᵢ] | 0 | 0 | 0 | 0 |

It also sets the vectors v_{m+1,t} for t∈[n′] corresponding to the (m+1)-th label function [symbol] as

| vector | [symbol] | [symbol] | [symbol] |
|---|---|---|---|
| υ_{m+1, t} | rₜ[m] | 1 | 0 |

Now, it uses the key generation algorithm of IPFE to generate the secret-keys

IPFE.SK_{j,t}←SK-IPFE.KeyGen(IPFE.MSK, [symbol] ) for j∈[m],t∈[n′]

[symbol]

←SK-IPFE.KeyGen( [symbol] , [symbol] ) for t∈[n′]

It returns the secret-key as SK_{ƒ,y}=({IPFE.SK_{j,t}}_{j∈[m],t∈[n′]}), { [symbol] }_{t∈[n′]}).

Remark. We note that the key-generation process can be performed if the vector y is not given in the clear but [symbol] ₂∈ [symbol] is known. This is because while running the IPFE.KeyGen algorithm above, the vectors v_{j,t} are not inputted in the clear but in the exponent of the group [symbol] . This fact will be used in the security analysis of our unbounded FE scheme.

Enc(MSK, (x, z∥w)∈X [symbol] × [symbol] ) It sets the following vectors:

| vector | const | coefᵢ | extnd_{κ} | query | sim_{τ} | sim_{τ}* |
|---|---|---|---|---|---|---|
| u | 1 | x[i] | w[κ] | 0 | 0 | 0 |

| vector | [symbol] | [symbol] | [symbol] |
|---|---|---|---|
| hₜ | −1 | z[t] | 0 |

for all t∈[n′]. Then, it encrypts the vectors using IPFE and obtain the ciphertexts

IPFE.CT←SK-IPFE.Enc(IPFE.MSK, [symbol] ₁)

[symbol]

←SK-IPFE.Enc( [symbol] , [symbol] ₁) for t∈[n′]

Finally, it returns the ciphertext as CT_{x,z∥w}=(IPFE.CT, { [symbol] }_{t∈[n′]}).

Dec((SK_{ƒ,y}, ƒ), (CT_{x,z∥w}, x)) It parses SK_{ƒ,y}=({IPFE.SK_{j,t}}_{j∈[m],t∈[n′]}, { [symbol] }_{t∈[n′]}) and CT_{x,z∥w}=(IPFE.CT, { [symbol] }_{t∈[n′]}). It uses the decryption algorithm of SK-IPFE to compute

[symbol]

←SK-IPFE.Dec(IPFE.SK_{1,t},IPFE.CT) for t∈[n′]

[symbol]

←SK-IPFE.Dec(IPFE.SK_{j,t},IPFE.CT) for j∈[2,m],t∈[n′]

[symbol]

←SK-IPFE.Dec( [symbol] , [symbol] ) for t∈[n′]

where ψₜ=νₜ·y^{T}w. Next, it utilizes the evaluation procedure of AKGS and returns the combined value

$${〚 ρ 〛}_{T} = {\prod }_{t ∈ [ {n}^{′} ]} Eval ( {f}_{t} , x , {〚 {ℓ}_{1 , t} + {ψ}_{t} 〛}_{T} , … , {〚 {ℓ}_{m + 1 , t} 〛}_{T} ) .$$

Correctness From the correctness of IPFE, we have SK-IPFE.Dec(IPFE.SK_{1,t}, IPFE.CT)= [symbol] + [symbol] _{T} where ψₜ=νₜ·y^{T}w. Next, using the correctness of IPFE and AKGS evaluation, we get

$$Eval ( {f}_{t} , x , {〚 {ℓ}_{1 , t} + {ψ}_{t} 〛}_{T} , … , {〚 {ℓ}_{m + 1 , t} 〛}_{T} ) = Eval ( {f}_{t} , x , {〚 {ℓ}_{1 , t} 〛}_{T} , … , {〚 {ℓ}_{m + 1 , t} 〛}_{T} + Eval ( {f}_{t} , x , {〚 {ψ}_{t} 〛}_{T} , {〚 0 〛}_{T} , … , {〚 0 〛}_{T} ) = {〚 z [ t ] {f}_{t} ( x ) + {β}_{t} + {ν}_{t} \cdot {y}^{T} w 〛}_{T}$$

The first equality follows from the linearity of Eval function. Now, multiplying all the evaluated values we have

$${〚 ρ 〛}_{T} = {\prod }_{t ∈ [ {n}^{′} ]} Eval ( {f}_{t} , x , {〚 {ℓ}_{1 , t} + {ψ}_{t} 〛}_{T} , … , {〚 {ℓ}_{m + 1 , t} 〛}_{T} ) = {〚 {\sum }_{t = 1}^{{n}^{′}} ( z [ t ] {f}_{t} ( x ) + {ν}_{t} \cdot {y}^{T} w + {β}_{t} ) 〛}_{T} = {〚 {f ( x )}^{T} z + {y}^{T} w 〛}_{T}$$

The last equality is obtained from the fact that Σ_{t∈[n′]}νₜ=1 and Σ_{t∈[n′]}βₜ=0.

### Bounded-Key One-Slot Extended FE for Attribute-Weighted Sums

In this section, we present a public-key one-slot FE scheme Π_{extOne}^{bdd} for an extended attribute-weighted sum functionality. This scheme is proven adaptively simulation secure against one ciphertext query, an a priori bounded number of pre-ciphertext secret key queries, and an arbitrary polynomial number of post-ciphertext secret key queries. We will apply a bootstrapping compiler onto this FE scheme to obtain our unbounded-slot FE scheme for attribute-weighted sums in the next section. We describe the construction for any fixed value of the security parameter λ and suppress the appearance of λ for simplicity of notations. Let (Garble, Eval) be a special piecewise secure AKGS for a function class [symbol] , G=(( [symbol] , [symbol] , [symbol] , g₁, g₂, e) a tuple of pairing groups of prime order p such that MDDHₖ holds in [symbol] , and (IPFE.Setup.IPFE.KeyGen, IPFE.Enc, IPFE.Dec) a slotted IPFE based on G. We construct an FE scheme for attribute-weighted sums with the message space [symbol] = [symbol] × [symbol] .

Setup(1^{λ}, 1ⁿ, 1^{n′}, 1^{B}) Defines the following index sets as follows

S_{pub}={{const^{(ι)}}_{ι∈[k]},{coefᵢ^{(ι)}}_{ι∈[k],i∈[n]},{extnd_{κ}^{(ι)}}_{ι,κ∈[k]}},Ŝ_{pub}={ [symbol] , [symbol] }_{ι∈[k]}

Sₚᵣᵢᵥ={const,{coefᵢ}_{i∈[n]},{extnd_{κ,1},extnd_{κ,2},extnd_{κ}}_{κ∈[k]},{query_{η}}_{η∈[B]},{sim_{τ},sim_{τ}*}_{τ∈[n′]}},

\hat{S}ₚᵣᵢᵥ={ [symbol] , [symbol] , [symbol] , [symbol] , [symbol] , [symbol] , [symbol] }

where B denotes a bound on the number of pre-challenge queries. It generates two pair of IPFE keys (IPFE.MSK, IPFE.MPK)←IPFE.Setup(S_{pub}, Sₚᵣᵢᵥ) and ( [symbol] , [symbol] )←IPFE.Setup(Ŝ_{pub}, Ŝₚᵣᵢᵥ). Finally, it returns the master secret-key of the system as MSK=(IPFE.MSK, [symbol]
) and master public-key as MPK=(IPFE.MPK, [symbol] ).

KeyGen(MSK, (ƒ,y)) Let ƒ=(ƒ₁, . . . , ƒ_{n′})∈ [symbol] and y∈ [symbol] . It samples integers νₜ← [symbol] and vectors α,βₜ← [symbol] for t∈[n′] such that

$${\sum }_{t ∈ [ {n}^{′} ]} {ν}_{t} = 1 and {\sum }_{t ∈ [ {n}^{′} ]} {β}_{t} [ ι ] = 0 mod p for all ι ∈ [ k ]$$

Next, sample independent random vectors rₜ^{(ι)}← [symbol] and computes

$$( {ℓ}_{1 , t}^{( ι )} , … , {ℓ}_{m , t}^{( ι )} , {ℓ}_{m + 1 , t}^{( ι )} ) ← Garble ( α [ ι ] z [ t ] {f}_{t} ( x ) + {β}_{t} [ ι ] ; {r}_{t}^{( ι )} )$$

for all ι∈[k], t∈[n′]. Here, we make use of the instantiation of the AKGS described in Section. From the description of that AKGS instantiation, we note that the (m+1), th label function [symbol] would be of the form [symbol] =α[ι]z[t]−rₜ^{(ι)}) [m] where α[ι] is a constant. Also all the label functions [symbol] , . . . , [symbol] involve only the variables x and not the variable z[t]. Next, for all j∈[2, m] and t∈[n′], it defines the vectors v_{j,t} corresponding to the label functions [symbol] obtained from the partial garbling above and the vector y as

| vector | const^{(ι)} | coefᵢ^{(ι)} | extnd_{κ}^{(ι)} | Sₚᵣᵢᵥ |
|---|---|---|---|---|
| v | α(ι) | 0 | 0 | 0 |
| v_{1, t} | [symbol] [const] | [symbol] [coefᵢ] | α[ι]y[κ]νₜ | 0 |
| v_{j, t} | [symbol] [const] | [symbol] [coefᵢ] | 0 | 0 |

| vector | [symbol] | [symbol] | Ŝₚᵣᵢᵥ |
|---|---|---|---|
| v_{m + 1, t} | rₜ^{(ι)}[m] | α[ι] | 0 |

It generates the secret-keys as

IPFE.SK←IPFE.KeyGen(IPFE.MSK, [symbol] )

IPFE.SK_{j,t}←IPFE.KeyGen(IPFE.MSK, [symbol] ) for j∈[m],t∈[n′]

[symbol]

←IPFE.KeyGen( [symbol] , [symbol] ) for t∈[n′]

Finally, it returns the secret-key as SK_{ƒ,y}=(IPFE.SK, {IPFE.SK_{j,t}}_{j∈[m],t∈[n′]}, { [symbol] }_{t∈[n′]}) and (ƒ,y).

Remark 4 We note that the vector y is only used to set v_{1,t}[extnd_{κ}^{(ι)}] and the IPFE.KeyGen only requires [symbol] ₂∈ [symbol] to compute the secret-key IPFE.SK_{1,t}. Therefore the key generation process can compute the same secret-key SK_{ƒ,y} if (ƒ, [symbol] ) is supplied as input instead of (ƒ,y) and we express this by writing KeyGen(MSK, (ƒ, [symbol] ))=Key-Gen(MSK, (ƒ,y)). This fact will be crucial while describing the unbounded slot FE.

Enc(MPK, (x, z∥w)∈ [symbol] × [symbol] ) It samples a random vector s← [symbol] and sets the vectors

| vector | const^{(ι)} | coefᵢ^{(ι)} | extnd_{κ}^{(ι)} |
|---|---|---|---|
| u | s[ι] | s[ι]x[i] | s[ι]w[κ] |

| vector | [symbol] | [symbol] |
|---|---|---|
| hₜ | −s[ι] | s[ι]z[t] |

for all t∈[n′]. It encrypts the vectors as

IPFE.CT←IPFE.SlotEnc(IPFE.MPK, [symbol] )

[symbol]

←IPFE.SlotEnc( [symbol] , [symbol] ) for t∈[n′]

and returns the ciphertext as CT=(IPFE.CT, { [symbol] }_{t∈[n′]}) and x.

Dec((SK_{ƒ,y}, ƒ), (CT, x)) It parses the secret-key and ciphertext as SK_{ƒ,y}=(IPFE.SK, {IPFE.SK_{j,t}}_{j∈[m],t∈[n′]}, { [symbol] }_{t∈[n′]}) and CT_{x,z}=(IPFE.CT, { [symbol] }_{t∈[n′]}). It uses the decryption algorithm of IPFE to compute

[symbol]

←IPFE.Dec(IPFE.SK,IPFE.CT)

[symbol]

+ [symbol] ←IPFE.Dec(IPFE.SK_{1,t},IPFE.CT)

[symbol]

←IPFE.Dec(IPFE.SK_{j,t},IPFE.CT) for j∈[2,m],t∈[n′]

[symbol]

←IPFE.Dec( [symbol] , [symbol] ) for t∈[n′]

where ψₜ=Σ_{ι=1}^{k}α[ι]s[ι]·νₜ·y^{T}w=α·s·νₜ·y^{T}w. Next, it utilizes the evaluation procedure of AKGS and obtain a combined value

$${〚 ζ 〛}_{T} = {\prod }_{t ∈ [ {n}^{′} ]} Eval ( {f}_{t} , x , {〚 {ℓ}_{1 , t} + {ψ}_{t} 〛}_{T} , … , {〚 {ℓ}_{m + 1 , t} 〛}_{T} ) .$$

Finally, it returns a value [symbol] = [symbol] · [symbol] ∈ [symbol] .

Correctness First, the IPFE correctness implies IPFE.Dec(IPFE.SK_{1,t}, IPFE.CT)= [symbol] + [symbol] where ψₜ=Σ_{ι=1}^{k}α[ι]s[ι]·νₜ·y^{T}w=α·s·νₜ·y^{T}w. Next, by the correctness of IPFE, AKGS we have

$$Eval ( {f}_{t} , x , {ℓ}_{1 , t} + {ψ}_{t} , … , {ℓ}_{m + 1 , t} ) = Eval ( {f}_{t} , x , {ℓ}_{1 , t} , … , {ℓ}_{m + 1 , t} ) + Eval ( {f}_{t} , x , {ψ}_{t} , 0 , … , 0 ) = Eval ( {f}_{t} , x , {ℓ}_{1 , t} , … , {ℓ}_{m + 1 , t} ) + {ψ}_{t} = {\sum }_{ι = 1}^{k} ( α [ ι ] s [ ι ] \cdot z [ t ] {f}_{t} ( x ) + {β}_{t} [ ι ] s [ ι ] ) + α \cdot s \cdot {ν}_{t} \cdot {y}^{T} w = α \cdot s \cdot ( z [ t ] {f}_{t} ( x ) + {ν}_{t} \cdot {y}^{T} w ) + {β}_{t} \cdot s$$

The first equality follows from the linearity of Eval algorithm. Therefore, multiplying all the evaluated values we have

$${〚 ζ 〛}_{T} = {\prod }_{t ∈ [ {n}^{′} ]} Eval ( {f}_{t} , x , {〚 {ℓ}_{1 , t} + {ψ}_{t} 〛}_{T} , … , {〚 {ℓ}_{m + 1 , t} 〛}_{T} ) = {〚 {\sum }_{t = 1}^{{n}^{′}} α \cdot s \cdot ( z [ t ] {f}_{t} ( x ) + {ν}_{t} \cdot {y}^{T} w ) + {β}_{t} \cdot s 〛}_{T} = {〚 α \cdot s \cdot ( {f ( x )}^{T} z + {y}^{T} w ) 〛}_{T}$$

where the last equality follows from the fact that Σ_{t∈n′}νₜ=1 mod p and Σ_{t∈[n′]}βₜ[ι]=0 mod p for all ι∈[k]. Also, by the correctness of IPFE we see that [symbol] = [symbol] and hence [symbol] = [symbol] .

Theorem 2 The extended one slot FE scheme Π_{extOne}^{bdd} for attribute-weighted sum is adaptively simulation-secure assuming the AKGS is piecewise-secure as per Definition 7, the MDDHₖ assumption holds in group [symbol] , and the slotted IPFE is function hiding as per Definition 5.

### 1-Key 1-Ciphertext Secure One-Slot Extended FE Designed for Unbounded-Key One-Slot Extended FE for Attribute-Weighted Sums

In this section, we present a private-key one-slot FE scheme for an extended attribute-weighted sum functionality that is proven simulation secure against a single ciphertext query and a single secret key query either before or after the ciphertext query. This scheme will be embedded into the hidden subspaces of the public-key multi-key FE scheme for the same functionality presented in the next section in its security proof. We describe the construction for any fixed value of the security parameter A and suppress the appearance of λ for simplicity of notations. Let (Garble, Eval) be special piecewise secure AKGS for a function class [symbol] , G=( [symbol] , [symbol] , [symbol] , [symbol] , g₂, e) a tuple of pairing groups of prime order p, and (IPFE.Setup, IPFE.KeyGen, IPFE.Enc, IPFE.Dec) a secret-key function-hiding SK-IPFE based on G.

Setup(1^{λ}, 1ⁿ, 1^{n′}) Define the following index sets as follows

S_{1-extFE}={const,{coefᵢ}_{i∈[n]},{extnd_{κ}}_{κ∈[k]},{sim_{τ},sim_{τ}*}_{τ∈[n′]}},

\hat{S}_{1-extFE}={ [symbol] , [symbol] , [symbol] }

It generates two IPFE master secret-keys IPFE.MSK←SK-IPFE.Setup(S_{1-extFE}) and [symbol] ←SK-IPFE.Setup(Ŝ_{1-extFE}). Finally, it returns MSK=(IPFE.MSK, [symbol] ).

KeyGen(MSK, (ƒ,y)) Let ƒ=(ƒ₁, . . . , ƒ_{n′})∈ [symbol] and y∈ [symbol] . Samples integers νₜ,βₜ← [symbol] for t∈[n′] such that

$${\sum }_{t ∈ [ {n}^{′} ]} {ν}_{t} = 1 and {\sum }_{t ∈ [ {n}^{′} ]} {β}_{t} = 0 modulo p .$$

Next, samples independent random vectors rₜ← [symbol] for garbling and computes the coefficient vectors

$$( {ℓ}_{1 , t} , … , {ℓ}_{m , t} , {ℓ}_{m + 1 , t} ) ← Garble ( z [ t ] {f}_{t} ( x ) + {β}_{t} , {r}_{t} )$$

for each t∈[n′]. Here we make use of the instantiation of the AKGS described in Section. From the description of that AKGS instantiation, we note that the (m+1)-th label function [symbol] would be of the form [symbol] =z[t]−rₜ[m]. Also all the label functions [symbol] , . . . , [symbol] involve only the variables x and not the variable z[t]. Next, for all j∈[m] and t∈[n′], it defines the vectors v_{j,t} corresponding to the label functions [symbol] obtained from the partial garbling above and the vector y as

| vector | const | coefᵢ | extnd_{κ} | sim_{τ} | sim_{τ}* |
|---|---|---|---|---|---|
| v_{1, t} | [symbol] [const] | [symbol] [coefᵢ] | y[κ]νₜ | 0 | 0 |
| v_{j, t} | [symbol] [const] | [symbol] [coefᵢ] | 0 | 0 | 0 |

It also sets the vectors v_{m+1,t} for t∈[n′] corresponding to the (m+1)-th label function [symbol] as

| vector | [symbol] | [symbol] | [symbol] |
|---|---|---|---|
| υ_{m+1, t} | rₜ[m] | 1 | 0 |

Now, it uses the key generation algorithm of IPFE to generate the secret-keys

IPFE.SK_{j,t}←SK-IPFE.KeyGen(IPFE.MSK, [symbol] ) for j∈[m],t∈[n′]

[symbol]

←SK-IPFE.KeyGen( [symbol] , [symbol] ) for t∈[n′]

It returns the secret-key as SK_{ƒ,y}=({IPFE.SK_{j,t}}j∈[m],t∈[n′]), { [symbol] }_{t∈[n′]}).

Enc(MSK, (x, z∥w)∈ [symbol] × [symbol] ) It sets the following vectors:

| vector | const | coefᵢ | extnd_{κ} | sim_{τ} | sim_{τ}* |
|---|---|---|---|---|---|
| u | 1 | x[i] | w[κ] | 0 | 0 |

| vector | [symbol] | [symbol] | [symbol] |
|---|---|---|---|
| hₜ | −1 | z[t] | 0 |

for all t∈[n′]. Then, it encrypts the vectors using IPFE and obtain the ciphertexts

IPFE.CT←SK-IPFE.Enc(IPFE.MSK, [symbol] ₁)

[symbol]

←SK-IPFE.Enc( [symbol] , [symbol] ₁) for t∈[n′]

Finally, it returns the ciphertext as CT_{x,z∥w}=(IPFE.CT, { [symbol] }_{t∈[n′]}).

Dec((SK_{ƒ,y}, ƒ), (CT_{x,z∥w}, x)) It parses SK_{ƒ,y}=({IPFE.SK_{j,t}}_{j∈[m],t∈[n′]}, { [symbol] }_{t∈[n′]}) and CT_{x,z∥w}=(IPFE.CT, { [symbol] ). It uses the decryption algorithm of SK-IPFE to compute

[symbol]

←SK-IPFE.Dec(IPFE.SK_{1,t},IPFE.CT) for t∈[n′]

[symbol]

←SK-IPFE.Dec(IPFE.SK_{j,t},IPFE.CT) for j∈[2,m],t∈[n′]

[symbol]

←SK-IPFE.Dec( [symbol] , [symbol] ) for t∈[n′]

where ψₜ=νₜ·y^{T}w. Next, it utilizes the evaluation procedure of AKGS and returns the combined value

$${〚 ρ 〛}_{T} = {\prod }_{t ∈ [ {n}^{′} ]} Eval ( {f}_{t} , x , {〚 {ℓ}_{1 , t} + {ψ}_{t} 〛}_{T} , … , {〚 {ℓ}_{m + 1 , t} 〛}_{T} ) .$$

Correctness From the correctness of IPFE, we have SK-IPFE.Dec(IPFE.SK_{1,t}, IPFE.CT)= [symbol] where ψₜ=νₜ·y^{T}w. Next, using the correctness of IPFE and AKGS evaluation, we get

$$Eval ( {f}_{t} , x , {〚 {ℓ}_{1 , t} + {ψ}_{t} 〛}_{T} , … , {〚 {ℓ}_{m + 1 , t} 〛}_{T} ) = Eval ( {f}_{t} , x , {〚 {ℓ}_{1 , t} 〛}_{T} , … , {〚 {ℓ}_{m + 1 , t} 〛}_{T} ) + Eval ( {f}_{t} , x , {〚 {ψ}_{t} 〛}_{T} , {〚 0 〛}_{T} , … , {〚 0 〛}_{T} ) = {〚 z [ t ] {f}_{t} ( x ) + {β}_{t} + {ν}_{t} \cdot {y}^{T} w 〛}_{T}$$

The first equality follows from the linearity of Eval function. Now, multiplying all the evaluated values we have

$${〚 ρ 〛}_{T} = {\prod }_{t ∈ [ {n}^{′} ]} Eval ( {f}_{t} , x , {〚 {ℓ}_{1 , t} + {ψ}_{t} 〛}_{T} , … , {〚 {ℓ}_{m + 1 , t} 〛}_{T} ) = {〚 {\sum }_{t = 1}^{{n}^{′}} ( z [ t ] {f}_{t} ( x ) + {ν}_{t} \cdot {y}^{T} w + {β}_{t} ) 〛}_{T} = {〚 {f ( x )}^{T} z + {y}^{T} w 〛}_{T}$$

The last equality is obtained from the fact that Σ_{t∈[n′]}νₜ=1 and Σ_{t∈[n′]}βₜ=0.

### Unbounded-Key One-Slot Extended FE for Attribute-Weighted Sums

In this section, we present a public-key one-slot FE scheme Π_{extOne}^{ubd} for an extended attribute-weighted sum functionality. This scheme is proven adaptively simulation secure against one ciphertext query and an arbitrary polynomial number of secret key queries both before and after the ciphertext query. We describe the construction for any fixed value of the security parameter λ and suppress the appearance of λ for simplicity of notations. Let (Garble, Eval be a special piecewise secure AKGS for a function class [symbol] , G=( [symbol] , [symbol] , [symbol] , g₁, g₂, e) a tuple of pairing groups of prime order p such that MDDHₖ holds in [symbol] , and (IPFE.Setup.IPFE.KeyGen, IPFE.Enc, IPFE.Dec) a slotted IPFE based on G. We construct an FE scheme for attribute-weighted sums with the message space [symbol] = [symbol] × [symbol] .

Setup(1^{λ}, 1ⁿ, 1^{n′}) Defines the following index sets as follows

S_{pub}={{const^{(ι)}}_{ι∈[k]},{coefᵢ^{(ι)}}_{ι∈[k],i∈[n]},{extnd_{κ}^{(ι)}}_{ι,κ∈[k]}},\hat{S}_{pub}={ [symbol] , [symbol] }_{ι∈[k]}

Sₚᵣᵢᵥ={const,{coefᵢ}_{i∈[n]},{extnd_{κ,1},extnd_{κ,2},extnd_{κ}}_{κ∈[k]},{sim_{τ},sim_{τ}*}_{τ∈[n′]}},

\hat{S}ₚᵣᵢᵥ={ [symbol] , [symbol] , [symbol] , [symbol] , [symbol] , [symbol] , [symbol] }

It generates two pair of IPFE keys (IPFE.MSK, IPFE.MPK)←IPFE.Setup(S_{pub}, Sₚᵣᵢᵥ) and ( [symbol] , [symbol] )←IPFE.Setup(Ŝ_{pub}, Ŝₚᵣᵢᵥ). Finally, it returns the master secret-key as MSK=(IPFE.MSK, [symbol] ) and master public-key as MPK=(IPFE.MPK, [symbol] ).

KeyGen(MSK, (ƒ,y)) Let ƒ=(ƒ₁, . . . , ƒ_{n′})∈ [symbol] and y∈ [symbol] . It samples integers νₜ← [symbol] , and vectors α,βₜ← [symbol] for t∈[n′] such that

$${\sum }_{t ∈ [ {n}^{′} ]} {v}_{t} = 1$$

$$and$$

$${\sum }_{t ∈ [ {n}^{′} ]} {β}_{t} [ ι ] = 0 mod p$$

$$for all$$

$$ι ∈ [ k ]$$

Next, sample independent random vectors rₜ^{(ι)}← [symbol] and computes

$$( {ℓ}_{1 , t}^{( ι )} , … , {ℓ}_{m , t}^{( ι )} , {ℓ}_{m + 1 , t}^{( ι )} ) ← Garble ( α [ ι ] z [ t ] {f}_{t} ( x ) + {β}_{t} [ ι ] ; {r}_{t}^{( ι )} )$$

for all ι∈[k], t∈[n′]. Here, we make use of the instantiation of the AKGS described in Section. From the description of that AKGS instantiation, we note that the (m+1)-th label function [symbol] would be of the form [symbol] =α[ι]z[t]−rₜ^{(ι)}[m] where α[ι] is a constant. Also all the label functions [symbol] , . . . , [symbol] involve only the variables x and not the variable z[t]. Next, for all j∈[2, m] and t∈[n′], it defines the vectors v_{j,t} corresponding to the label functions [symbol] obtained from the partial garbling above and the vector y as

| vector | const^{(ι)} | coefᵢ^{(ι)} | extnd_{κ}^{(ι)} | Sₚᵣᵢᵥ |
|---|---|---|---|---|
| v | α[ι] | 0 | 0 | 0 |
| v_{1, t} | [symbol] [const] | [symbol] [coefᵢ] | α[ι]y[κ]νₜ | 0 |
| v_{j, t} | [symbol] [const] | [symbol] [coefᵢ] | 0 | 0 |

| vector | [symbol] | [symbol] | Ŝₚᵣᵢᵥ |
|---|---|---|---|
| v_{m + 1, t} | rₜ^{(ι)}[m] | α[ι] | 0 |

It generates the secret-keys as

IPFE.SK←IPFE.KeyGen(IPFE.MSK, [symbol] )

IPFE.SK_{j,t}←IPFE.KeyGen(IPFE.MSK, [symbol] ) for j∈[m],t∈[n′]

[symbol]

←IPFE.KeyGen( [symbol] , [symbol] ) for t∈[n′]

Finally, it returns SK_{ƒ,y}=(IPFE.SK, {IPFE.SK_{j,t}}_{j∈[m],t∈[n′]}, { [symbol] }_{t∈[n′]}) and (ƒ,y).

Enc(MPK, (x, z∥w)∈ [symbol] × [symbol] ) It samples a random vector s← [symbol] and sets the vectors

| vector | const^{(ι)} | coefᵢ^{(ι)} | extnd_{κ}^{(ι)} |
|---|---|---|---|
| u | s[ι] | s[ι]x[i] | s[ι]w[κ] |

| vector | [symbol] | [symbol] |
|---|---|---|
| hₜ | −s[ι] | s[ι]z[t] |

for all t∈[n′]. It encrypts the vectors as

IPFE.CT←IPFE.SlotEnc(IPFE.MPK, [symbol] )

[symbol]

←IPFE.SlotEnc( [symbol] , [symbol] ) for t∈[n′]

and returns the ciphertext as CT=(IPFE.CT, { [symbol] }_{t∈[n′]}) and x.

Dec((SK_{ƒ,y}, ƒ), (CT, x)) It parses the secret-key as SK_{ƒ}=(IPFE.SK, {IPFE.SK_{j,t}}_{j∈[m],t∈[n′]}, { [symbol] }_{t∈[n′]}) and the ciphertext as CT_{x,z}=(IPFE.CT, { [symbol] ). It uses the decryption algorithm of IPFE to compute

[symbol]

←IPFE.Dec(IPFE.SK,IPFE.CT)

[symbol]

←IPFE.Dec(IPFE.SK_{1,t},IPFE.CT)

[symbol]

←IPFE.Dec(IPFE.SK_{j,t},IPFE.CT) for j∈[2,m],t∈[n′]

[symbol]

←IPFE.Dec( [symbol] , [symbol] ) for t∈[n′]

where ψₜ=Σ_{ι=1}^{k}α[ι]s[ι]·νₜ·y^{T}w=α·s·νₜ·y^{T}w. Next, it utilizes the evaluation procedure of AKGS and obtain a combined value

$${〚 ζ 〛}_{T} = {\prod }_{t ∈ [ {n}^{′} ]} Eval ( {f}_{t} , x , {〚 {ℓ}_{1 , t} + {ψ}_{t} 〛}_{T} , … , {〚 {ℓ}_{m + 1 , t} 〛}_{T} ) .$$

Finally, it returns a value [symbol] = [symbol] · [symbol] ∈ [symbol] .

Correctness First, the IPFE correctness implies IPFE.Dec(IPFE.SK_{1,t}, IPFE.CT)= [symbol] + [symbol] where ψₜ=Σ_{ι=1}^{k}α[ι]s[ι]·νₜ·y^{T}w=α·s·νₜ·y^{T}w. Next, by the correctness of IPFE, AKGS we have

$$\begin{matrix}Eval ( {f}_{t} , x , {ℓ}_{1 , t} + {ψ}_{t} , … , {ℓ}_{m + 1 , t} ) = Eval ( {f}_{t} , x , {ℓ}_{1 , t} , … , {ℓ}_{m + 1 , t} ) + \\ Eval ( {f}_{t} , x , {ψ}_{t} , 0 , … , 0 ) \\ = Eval ( {f}_{t} , x , {ℓ}_{1 , t} , … , {ℓ}_{m + 1 , t} ) + {ψ}_{t} \\ = {\sum }_{ι = 1}^{k} ( α [ ι ] s [ ι ] \cdot z [ t ] {f}_{t} ( x ) + {β}_{t} [ ι ] s [ ι ] ) + \\ α \cdot s \cdot {v}_{t} \cdot {y}^{T} w \\ = α \cdot s \cdot ( z [ t ] {f}_{t} ( x ) + {v}_{t} \cdot {y}^{T} w ) + {β}_{t} \cdot s\end{matrix}$$

The first equality follows from the linearity of Eval algorithm. Therefore, multiplying all the evaluated values we have

$$\begin{matrix}〚 ζ 〛 = {\prod }_{t ∈ [ {n}^{′} ]} Eval ( {f}_{t} , x , {〚 {ℓ}_{1 , t} + {ψ}_{t} 〛}_{T} , … , {〚 {ℓ}_{m + 1 , t} 〛}_{T} ) \\ = {〚 {\sum }_{t = 1}^{{n}^{′}} α \cdot s \cdot ( z [ t ] {f}_{t} ( x ) + {v}_{t} \cdot {y}^{T} w ) + {β}_{t} \cdot s 〛}_{T} \\ = {〚 α \cdot s \cdot ( {f ( x )}^{T} z + {y}^{T} w ) 〛}_{T}\end{matrix}$$

where the last equality follows from the fact that Σ_{t∈n′}νₜ=1 and Σ_{t∈[n′]}βₜ[ι]=0 for all ι∈[k]. Also, by the correctness of IPFE we see that [symbol] _{T}= [symbol] and hence [symbol] = [symbol] .

### System Implementations

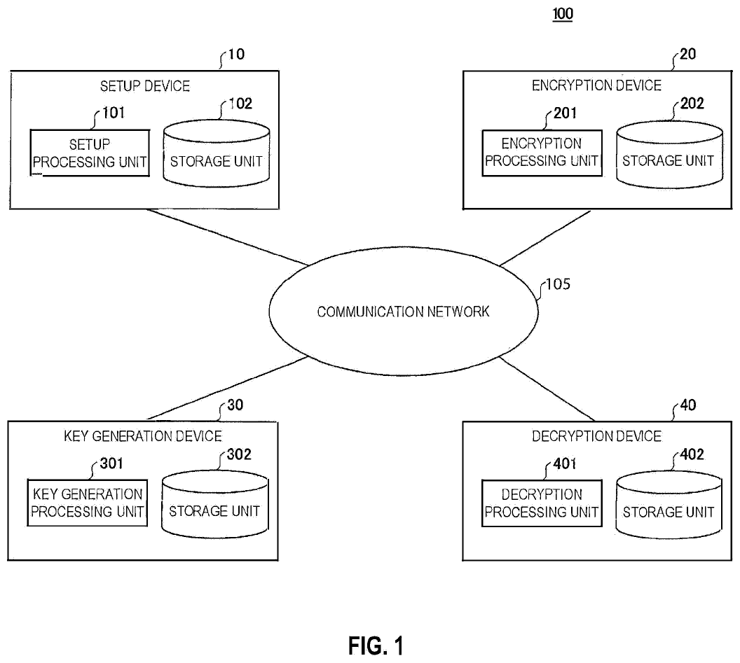

FIG. 1 illustrates an encryption system 100 in an embodiment of the present invention including a setup algorithm Setup, an encryption algorithm Enc, a key generation algorithm KeyGen, and a decryption algorithm Dec of the functional encryption implementations.

As illustrated in FIG. 1, the encryption system 100 in the embodiment of the present invention includes a setup device 10, an encryption device 20, a key generation device 30, and a decryption device 40. These devices are communicably connected to each other via a communication network 105.

The setup device 10 can be a computer or a computer system configured to execute the setup algorithm Setup. The setup device 10 includes a setup processing unit 101 and a storage unit 102. The setup processing unit 101 executes the setup algorithm Setup as described herein. In the setup algorithm Setup, a functional encryption setup algorithm executes twice to generate and output a set of master public-secret key pairs FE.MSK and FE.MPK and a set of master public-secret key pairs [symbol] and [symbol] . The first set can be for encrypting a public part of attributes and the second set can be for use in encrypting a private part of the attributes. In the storage unit 102, various types of information used in the setup algorithm Setup, an output result of the setup algorithm Setup, and the like are stored.

Note that the setup processing unit 101 can be implemented by the processing of executing, by an arithmetic device such as a processor, one or more programs installed in the setup device 10, for example. The storage unit 102 can be implemented using various memories (e.g., a main storage device and an auxiliary storage device).

The encryption device 20 can be a computer or a computer system configured to execute the encryption algorithm Enc. The encryption device 20 includes an encryption processing unit 201 and a storage unit 202. The encryption processing unit 201 executes the encryption algorithm Enc by using, as input, the master public key MPK as FE.MPK and [symbol] one or more public attributes x, and one or more private attributes z. In the encryption algorithm Enc, a ciphertext CT as FE.CT and [symbol] , is generated and output. The storage unit 202 stores various types of information used in the encryption algorithm Enc, an output result (e.g., the ciphertext) of the encryption algorithm Enc, and the like are stored.

Note that the encryption processing unit 201 can be implemented by the processing of executing, by an arithmetic device such as a processor, one or more programs installed in the encryption device 20, for example. The storage unit 202 can be implemented using various memories (e.g., a main storage device and an auxiliary storage device).

The key generation device 30 is a computer or a computer system configured to execute the key generation algorithm KeyGen. The key generation device 30 can include a key generation processing unit 301 and a storage unit 302. The key generation processing unit 301 executes the key generation algorithm KeyGen by receiving the master secret key MSK as FE.MSK and [symbol] and a function ƒ where ƒ consists of sub-functions ƒₜ, wherein t represents an integer index. In the key generation algorithm KeyGen, the secret key SK_{ƒ} as FE.SK, {FE.SK_{j,t}}, [symbol] and ƒ are generated and output. In the storage unit 302, various types of information used in the key generation algorithm KeyGen, an output result of the key generation algorithm KeyGen, and the like are stored.

Note that the key generation processing unit 301 is implemented by the processing of executing, by an arithmetic device such as a processor, one or more programs installed in the key generation device 30, for example. The storage unit 302 can be implemented using various memories (e.g., a main storage device and an auxiliary storage device).

The decryption device 40 can be a computer or a computer system configured to execute the decryption algorithm Dec. The decryption device 40 includes a decryption processing unit 401 and a storage unit 402. The decryption processing unit 401 executes the decryption algorithm Dec by using, as input, the function ƒ and the secret key SK_{ƒ} for function ƒ. In the decryption algorithm Dec, the functional value μ is recovered from ρ and d, and generates and outputs the value μ as the plaintext. In the storage unit 402, various types of information used in the decryption algorithm Dec, an output result of the decryption algorithm Dec, and the like are stored.

Note that the decryption processing unit 401 is implemented by the processing of executing, by an arithmetic device such as a processor, one or more programs installed in the decryption device 40, for example. The storage unit 402 can be implemented using various memories (e.g., a main storage device and an auxiliary storage device).

The configuration of the encryption system 100 illustrated in FIG. 1 is an example, and other configurations may be employed. For example, any two or more devices of the setup device 10, the encryption device 20, and the key generation device 30 may be configured as a single device. The encryption system 100 may include a plurality of decryption devices 40. Similarly, any one or more devices of the setup device 10, the encryption device 20, and the key generation device 30 may be provided as a plurality of devices.

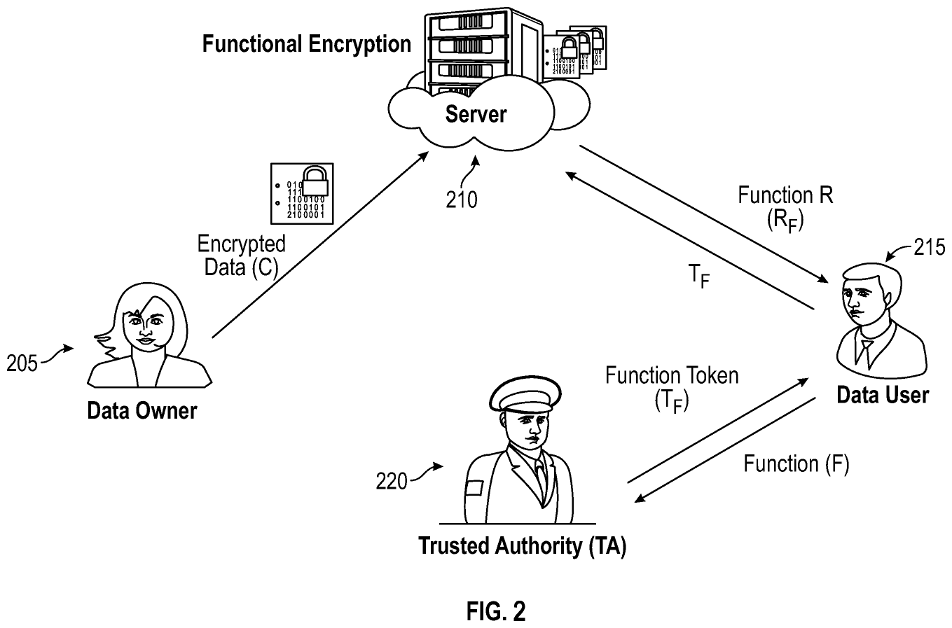

With reference to FIG. 2, an example system architecture is illustrated. A user 215 allows a remote server 210 to run a specific function F on a ciphertext by issuing a token T_{F}. The server executes F on an available ciphertext C and generates a result R_{F} an encrypted form. The system can include a trusted authority (TA) 220 who is responsible to construct a token T_{F} for the requested function.

As illustrated, data owner 205 uploads ciphertext C onto the remote server 210. Data user 215 requests TA 220 for a token for a function F. TA 220 issues token T_{F} to the data user. Data user then sends T_{F} to the server. Server runs F on the encrypted data, and forwards the result R_{F} to the data user.

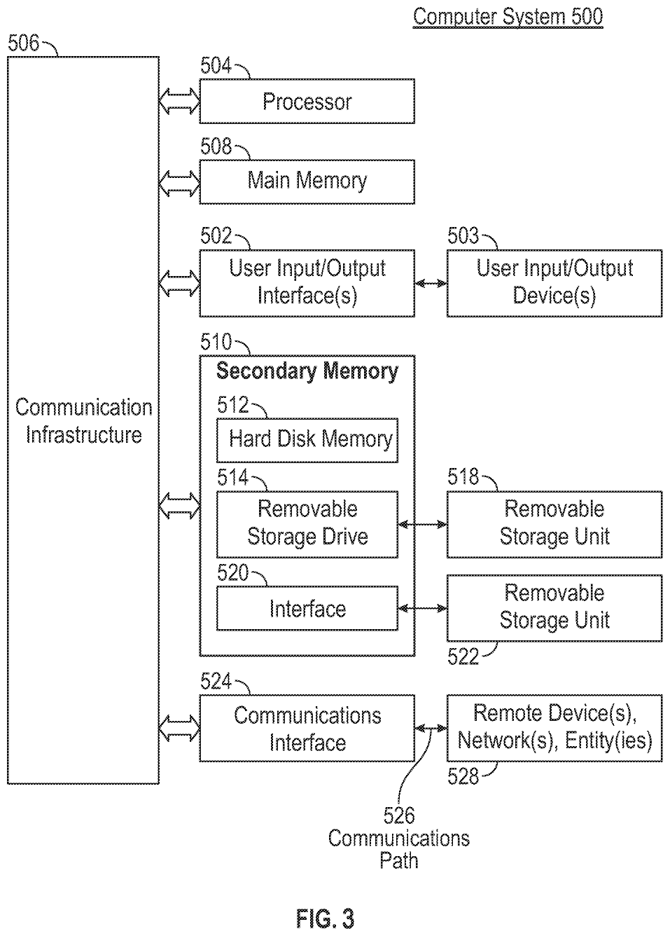

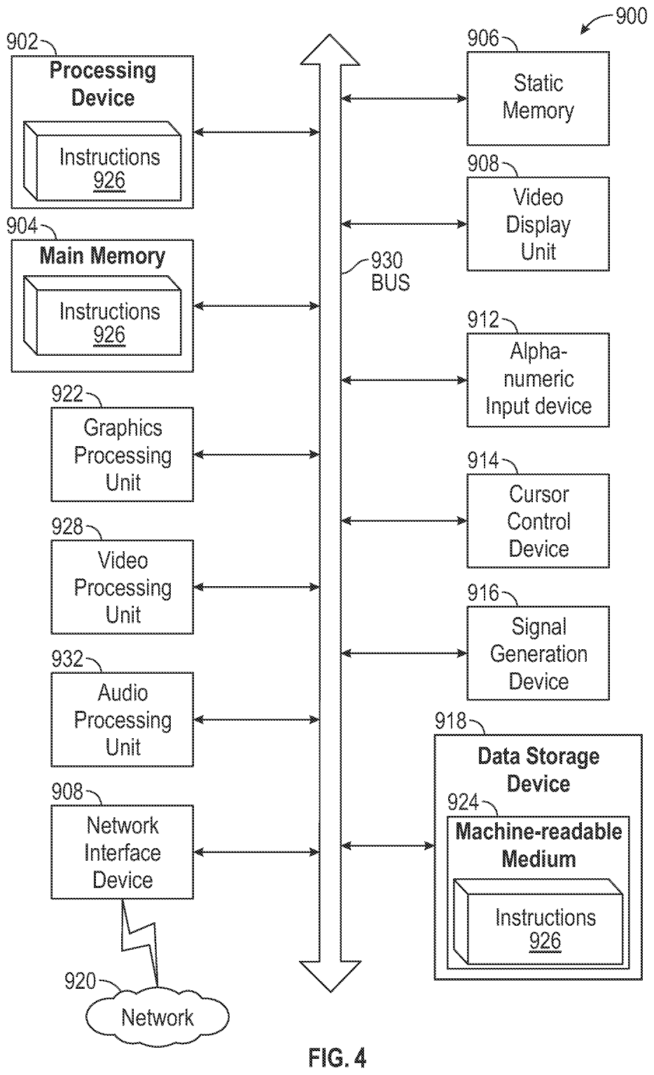

FIGS. 3 and 4 depict example computer systems useful for implementing various embodiments described in the present disclosure. Various embodiments may be implemented, for example, using one or more computer systems, such as computer system 500 shown in FIG. 3. One or more computer system(s) 500 may be used, for example, to implement any of the embodiments discussed herein, as well as combinations and sub-combinations thereof.

Computer system 500 may include one or more processors (also called central processing units, processing devices, or CPUs), such as a processor 504. Processor 504 may be connected to a communication infrastructure 506 (e.g., such as a bus).

Computer system 500 may also include user input/output device(s) 503, such as monitors, keyboards, pointing devices, etc., which may communicate with communication infrastructure 506 through user input/output interface(s) 502. One or more of processors 504 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 500 may also include a main memory 508, such as random-access memory (RAM). Main memory 508 may include one or more levels of cache. Main memory 508 may have stored therein control logic (i.e., computer software, instructions, etc.) and/or data. Computer system 500 may also include one or more secondary storage devices or secondary memory 510. Secondary memory 510 may include, for example, a hard disk drive 512 and/or a removable storage device or removable storage drive 514. Removable storage drive 514 may interact with a removable storage unit 518. Removable storage unit 518 may include a computer-usable or readable storage device having stored thereon computer software (control logic) and/or data. Removable storage drive 514 may read from and/or write to removable storage unit 518.

Secondary memory 510 may include other means, devices, components, instrumentalities, or other approaches for allowing computer programs and/or other instructions and/or data to be accessed by computer system 500. Such means, devices, components, instrumentalities, or other approaches may include, for example, a removable storage unit 522 and an interface 520. Examples of the removable storage unit 522 and the interface 520 may include a program cartridge and cartridge interface, a removable memory chip (such as an EPROM or PROM) and associated socket, a memory stick and USB port, a memory card and associated memory card slot, and/or any other removable storage unit and associated interface.

Computer system 500 may further include communications interface 524 (e.g., network interface). Communications interface 524 may enable computer system 500 to communicate and interact with any combination of external devices, external networks, external entities, etc. (individually and collectively referenced as remote device(s), network(s), entity(ies) 528). For example, communications interface 524 may allow computer system 500 to communicate with external or remote device(s), network(s), entity(ies) 528 over communications path 526, which may be wired and/or wireless (or a combination thereof), and which may include any combination of LANs, WANs, the Internet, etc. Control logic and/or data may be transmitted to and from computer system 500 via communications path 526.

Computer system 500 may also be any of a personal digital assistant (PDA), desktop workstation, laptop or notebook computer, netbook, tablet, smartphone, smartwatch or other wearable devices, appliance, part of the Internet-of-Things, and/or embedded system, to name a few non-limiting examples, or any combination thereof.

Computer system 500 may be a client or server computing device, accessing or hosting any applications and/or data through any delivery paradigm, including but not limited to remote or distributed cloud computing solutions; local or on-premises software (“onpremise”cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

FIG. 4 illustrates an example machine of a computer system 900 within which a set of instructions, for causing the machine to perform any one or more of the operations discussed herein, may be executed. In alternative implementations, the machine may be connected (e.g., networked) to other machines in a LAN, an intranet, an extranet, and/or the Internet. The machine may operate in the capacity of a server or a client machine in a client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, a specialized application or network security appliance or device, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 900 includes a processing device 902, a main memory 904 (e.g., read-only memory (ROM), flash memory, dynamic random-access memory (DRAM) such as synchronous DRAM (SDRAM), etc.), a static memory 906 (e.g., flash memory, static random-access memory (SRAM), etc.), and a data storage device 918, which communicate with each other via a bus 930.

Processing device 902 represents one or more processing devices such as a microprocessor, a central processing unit, or the like. More particularly, the processing device may be complex instruction set computing (CISC) microprocessor, reduced instruction set computing (RISC) microprocessor, very long instruction word (VLIW) microprocessor, or processor implementing other instruction sets, or processors implementing a combination of instruction sets. Processing device 902 may also be one or more special-purpose processing devices such as an application-specific integrated circuit (ASIC), a field-programmable gate array (FPGA), a digital signal processor (DSP), network processor, or the like. The processing device 902 is configured to execute instructions 926 for performing the operations and steps discussed herein.

The computer system 900 may further include a network interface device 908 to communicate over the network 920. The computer system 900 also may include a video display unit 910, an alphanumeric input device 912 (e.g., a keyboard), a cursor control device 914 (e.g., a mouse), a graphics processing unit 922, a signal generation device 916 (e.g., a speaker), graphics processing unit 922, video processing unit 928, and audio processing unit 932.

The data storage device 918 may include a machine-readable medium 924 (also known as a computer-readable storage medium) on which is stored one or more sets of instructions 926 (e.g., software instructions) embodying any one or more of the operations described herein. The instructions 926 may also reside, completely or at least partially, within the main memory 904 and/or within the processing device 902 during execution thereof by the computer system 900, where the main memory 904 and the processing device 902 also constitute machine-readable storage media.

In an example, the instructions 926 include instructions to implement operations and functionality corresponding to the disclosed subject matter. While the machine-readable storage medium 924 is shown in an example implementation to be a single medium, the term “machine-readable storage medium” should be taken to include a single medium or multiple media (e.g., a centralized or distributed database, and/or associated caches and servers) that store the one or more sets of instructions 926. The term “machine-readable storage medium” shall also be taken to include any medium that is capable of storing or encoding a set of instructions 926 for execution by the machine and that cause the machine to perform any one or more of the operations of the present disclosure. The term “machine-readable storage medium” shall accordingly be taken to include, but not be limited to, solid-state memories, optical media, and magnetic media.

Some portions of the detailed description have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a computer selectively activated or reconfigured by a computer program stored in the computer. Such a computer program may be stored in a computer-readable storage medium, such as but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The operations and illustrations presented herein are not inherently related to any particular computer or other apparatus. Various types of systems may be used with programs in accordance with the teachings herein, or it may prove convenient to construct a more specialized apparatus to perform the operations. The structure for a variety of these systems will appear as set forth in the description herein. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as read-only memory (“ROM”), random access memory (“RAM”), magnetic disk storage media, optical storage media, flash memory devices, etc.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500), may cause such data processing devices to operate as described herein.

Based on the teachings contained in this disclosure, it will be apparent to persons skilled in the relevant art(s) how to make and use embodiments of this disclosure using data processing devices, computer systems, and/or computer architectures other than that shown in FIGS. 3 and 4. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible and are within the scope and spirit of this disclosure. For example, and without limiting the generality of this paragraph, embodiments are not limited to the software, hardware, firmware, and/or entities illustrated in the figures described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the abovedescribed exemplary embodiments but should be defined only in accordance with the following claims and their equivalents. In the foregoing specification, implementations of the disclosure have been described with reference to specific example implementations thereof. It will be evident that various modifications may be made thereto without departing from the broader spirit and scope of implementations of the disclosure as set forth in the following claims. The specification and drawings are, accordingly, to be regarded in an illustrative sense rather than a restrictive sense.

1. A computerized method for encrypting for a functional encryption scheme, the method comprising:
executing a computerized setup algorithm, the setup algorithm comprising:
executing a functional encryption setup algorithm twice to generate a set of master public-secret key pairs FE.MSK and FE.MPK and a set of master public-secret key pairs [symbol] and [symbol] ;
outputting a master secret key MSK as FE.MSK and [symbol] and a master public key MPK as FE.MPK and [symbol] , and storing the output master keys in an electronic setup storage unit;
executing a computerized key generation algorithm by:
receiving the master secret key MSK as FE.MSK and [symbol] from the setup storage unit and a function ƒ where ƒ comprises sub-functions ƒₜ, wherein t represents an integer index;
sampling random values α, βₜ such that the sum of all entries of βₜ is 0;
sampling random values rₜ for input for a garbling procedure, wherein the garbling procedure randomizes a function comprising α, ƒₜ, βₜ, wherein α and βₜ are secrets, and the garbling procedure outputs a set of label functions { [symbol] } where j runs over the number of label functions;
setting values v as α and generating an FE secret key FE.SK for the values v;
setting values v_{1,t} comprising fit [symbol] , α, and generating an FE secret key FE.SK_{1,1} for the values v_{1,t};
setting values v_{j,t} as [symbol] , and generating a FE secret key FE.SK_{j,t} for the values v_{j,t};
setting values \hat{v}ₜ comprising rₜ, α;
generating a functional encryption secret key [symbol] for the values vₜ; and
outputting the secret key SK_{ƒ} as FE.SK, {FE.SK_{j,t}}, [symbol] and ƒ, and storing the output in an electronic key generation storage unit.

2. The method of claim 1, further comprising an encryption method, the encryption method comprising:
receiving the master public key MPK as FE.MPK and [symbol] , one or more public attributes x, and one or more private attributes z;
sampling randomness s and setting values u comprising s, x, and computing FE ciphertext FE.CT for the value u;
setting values hₜ comprising of s and z, and computing FE ciphertext [symbol] , for the value hₜ; and
outputting the ciphertext CT as FE.CT and [symbol] and storing the output in an electronic encryption device storage unit.

3. The method of claim 2, further comprising a decryption method, the decryption method comprising:
receiving the function ƒ and the secret key SK_{ƒ} for function ƒ;
receiving one or more public attributes x and a ciphertext CT for x;
retrieving FE.SK, FE.SK_{j,t}, [symbol] from SK_{ƒ} and retrieving FE.CT and [symbol] from CT;
retrieving sub-functions ƒₜ from the function ƒ;
decrypting FE.CT by running the decryption algorithm of FE using the secret key FE.SK and get a value ρ;
decrypting FE.CT by running the decryption algorithm of FE using the secret key FE.SK_{j,t} and get a value [symbol] ;
decrypting [symbol] by running the decryption algorithm of FE using the secret key [symbol] and get a value [symbol] ;
running the evaluation algorithm of the garbling scheme using the values [symbol] , [symbol] and the one or more public attributes x and the sub-function ƒₜ, and get a value d; and
recovering the functional value μ from ρ and d, and outputting the value μ as the plaintext and storing the output in an electronic decryption device storage unit.

4. The method of claim 1, wherein the first set is for encrypting a public part of attributes and the second set is for use in encrypting a private part of the attributes.

5. A system for encrypting for a functional encryption scheme, comprising a processor, wherein the processor is configured for:
executing a computerized setup algorithm, the setup algorithm comprising:
executing a functional encryption setup algorithm twice to generate a set of master public-secret key pairs FE.MSK and FE.MPK and a set of master public-secret key pairs [symbol] and [symbol] ;
outputting a master secret key MSK as FE.MSK and [symbol] and a master public key MPK as FE.MPK and [symbol] , and storing the output master keys in an electronic setup storage unit;
executing a computerized key generation algorithm by:
receiving the master secret key MSK as FE.MSK and [symbol] from the setup storage unit and a function ƒ where ƒ comprises sub-functions ƒₜ, wherein t represents an integer index;
sampling random values α, βₜ such that the sum of all entries of βₜ is 0;
sampling random values rₜ for input for a garbling procedure, wherein the garbling procedure randomizes a function comprising α, ƒₜ, βₜ, wherein α and βₜ are secrets, and the garbling procedure outputs a set of label functions { [symbol] } where j runs over the number of label functions;
setting values v as α and generating an FE secret key FE.SK for the values v;
setting values v_{1,t} comprising [symbol] , α, and generating an FE secret key FE.SK_{1,t} for the values v_{1,t};
setting values v_{j,t} as [symbol] , and generating a FE secret key FE.SK_{j,t} for the values v_{j,t};
setting values vₜ comprising rₜ, α;
generating a functional encryption secret key [symbol] for the values \hat{v}ₜ; and
outputting the secret key SK_{ƒ} as FE.SK, {FE.SK_{j,t}}, { [symbol] } and ƒ, and storing the output in an electronic key generation storage unit.

6. The system of claim 5, wherein the processor is further configured for:
receiving the master public key MPK as FE.MPK and [symbol] , one or more public attributes x, and one or more private attributes z;
sampling randomness s and setting values u comprising s, x, and computing FE ciphertext FE.CT for the value u;
setting values hₜ comprising of s and z, and computing FE ciphertext [symbol] for the value hₜ; and
outputting the ciphertext CT as FE.CT and [symbol] and storing the output in an electronic encryption device storage unit.

7. The system of claim 6, wherein the processor is further configured for:
receiving the function ƒ and the secret key SK_{ƒ} for function ƒ;
receiving one or more public attributes x and a ciphertext CT for x;
retrieving FE.SK, FE.SK_{j,t}, [symbol] from SK_{ƒ} and retrieving FE.CT and [symbol] from CT;
retrieving sub-functions ƒₜ from the function ƒ;
decrypting FE.CT by running the decryption algorithm of FE using the secret key FE.SK and get a value ρ;
decrypting FE.CT by running the decryption algorithm of FE using the secret key FE.SK_{j,t} and get a value [symbol] ;
decrypting [symbol] by running the decryption algorithm of FE using the secret key [symbol] and get a value [symbol] ;
running the evaluation algorithm of the garbling scheme using the values [symbol] , [symbol] and the one or more public attributes x and the sub-function ƒₜ, and get a value d; and
recovering the functional value μ from ρ and d, and outputting the value μ as the plaintext and storing the output in an electronic decryption device storage unit.

8. The system of claim 5, wherein the first set is for encrypting a public part of attributes and the second set is for use in encrypting a private part of the attributes.

9. One or more tangible, non-transitory, machine-readable media comprising instructions configured to cause a processor to encrypt for a functional encryption scheme, wherein processing the functional encryption scheme comprises:
executing a computerized setup algorithm, the setup algorithm comprising:
executing a functional encryption setup algorithm twice to generate a set of master public-secret key pairs FE.MSK and FE.MPK and a set of master public-secret key pairs [symbol] and [symbol] ;
outputting a master secret key MSK as FE.MSK and [symbol] and a master public key MPK as FE.MPK and [symbol] , and storing the output master keys in an electronic setup storage unit;
executing a computerized key generation algorithm by:
receiving the master secret key MSK as FE.MSK and [symbol] from the setup storage unit and a function ƒ where ƒ comprises sub-functions ƒₜ, wherein t represents an integer index;
sampling random values α, βₜ such that the sum of all entries of βₜ is 0;
sampling random values rₜ for input for a garbling procedure, wherein the garbling procedure randomizes a function comprising α, ƒₜ, βₜ, wherein α and βₜ are secrets, and the garbling procedure outputs a set of label functions { [symbol] } where j runs over the number of label functions;
setting values v as α and generating an FE secret key FE.SK for the values v;
setting values v_{1,t} comprising [symbol] , α, and generating an FE secret key FE.SK_{1,t} for the values v_{1,t};
setting values v_{j,t} as [symbol] , and generating a FE secret key FE.SK_{j,t} for the values v_{j,t};
setting values \hat{v}ₜ comprising rₜ, α;
generating a functional encryption secret key [symbol] for the values \hat{v}ₜ; and
outputting the secret key SK_{ƒ} as FE.SK, {FE.SK_{j,t}}, { [symbol] } and ƒ, and storing the output in an electronic key generation storage unit.

10. The one or more machine-readable media of claim 9, wherein processing the encryption method further comprises:
receiving the master public key MPK as FE.MPK and [symbol] , one or more public attributes x, and one or more private attributes z;
sampling randomness s and setting values u comprising s, x, and computing FE ciphertext FE.CT for the value u;
setting values hₜ comprising of s and z, and computing FE ciphertext [symbol] for the value hₜ; and
outputting the ciphertext CT as FE.CT and [symbol] and storing the output in an electronic encryption device storage unit.

11. The one or more machine-readable media of claim 10, wherein processing the encryption method further comprises:
receiving the function ƒ and the secret key SK_{ƒ} for function ƒ;
receiving one or more public attributes x and a ciphertext CT for x;
retrieving FE.SK, FE.SK_{j,t}, [symbol] from SK_{ƒ} and retrieving FE.CT and [symbol] from CT;
retrieving sub-functions ƒₜ from the function ƒ;
decrypting FE.CT by running the decryption algorithm of FE using the secret key FE.SK and get a value ρ;
decrypting FE.CT by running the decryption algorithm of FE using the secret key FE.SK_{j,t} and get a value [symbol] ;
decrypting [symbol] by running the decryption algorithm of FE using the secret key [symbol] , and get a value [symbol] ;
running the evaluation algorithm of the garbling scheme using the values [symbol] , [symbol] and the one or more public attributes x and the sub-function ƒₜ, and get a value d; and
recovering the functional value μ from ρ and d, and outputting the value μ as the plaintext and storing the output in an electronic decryption device storage unit.

12. The one or more machine-readable media of claim 9, wherein the first set is for encrypting a public part of attributes and the second set is for use in encrypting a private part of the attributes.
